(19) United States
(12) Patent Application Publication
(10) Pub. No.: US 2023/0259046 A1
(43) Pub. Date: Aug. 17, 2023

(54) ELECTROPHOTOGRAPHIC PHOTORECEPTOR, CARTRIDGE USING SAME, AND IMAGE FORMING DEVICE

(71) Applicant: Mitsubishi Chemical Corporation, Tokyo (JP)

(72) Inventors: Takahiro Choda, Tokyo (JP); Yuka Nagao, Tokyo (JP); Akira Ando, Tokyo (JP)

(73) Assignee: Mitsubishi Chemical Corporation, Tokyo (JP)

(21) Appl. No.: 18/136,537

(22) Filed: Apr. 19, 2023

Related U.S. Application Data
(63) Continuation of application No. PCT/JP2021/038795, filed on Oct. 20, 2021.

(30) Foreign Application Priority Data
Oct. 21, 2020 (JP) 2020-176998

(51) Int. Cl. G03G 5/147; G03G 5/047

(52) U.S. Cl. CPC G03G 5/14791; G03G 5/14795; G03G 5/14734; G03G 5/047

(57) ABSTRACT

There is provided an electrophotographic photoreceptor including: a conductive support; and a photosensitive layer and a protective layer containing a cured product obtained by curing a curable compound, which are sequentially disposed on the conductive support. An area ratio A/B is 0.0045 or less, where A is an absorbance area at a wavelength of 1647 cm⁻¹ to 1627 cm⁻¹ and B is an absorbance area of a peak at a wavelength of 1800 cm⁻¹ to 1647 cm⁻¹ in an infrared absorption spectrum measurement of the protective layer. The photosensitive layer contains at least a hole transport material (HTM) and a radical acceptor compound. The electrophotographic photoreceptor is an electrophotographic photoreceptor including a protective layer with a high curing degree and having good initial electrical characteristics, excellent strong exposure characteristics, and excellent transfer repeatability.

### TECHNICAL FIELD

The present invention relates to an electrophotographic photoreceptor to be used in a copier, a printer, and the like, and a cartridge and an image forming device using the same.

### BACKGROUND ART

In a printer, a copier, and the like, when a charged organic photoreceptor (OPC) drum is irradiated with light, a charge is eliminated from the portion to generate an electrostatic latent image, and a toner adheres to the electrostatic latent image, whereby an image can be obtained. In devices using such electrophotographic technology, a photoreceptor is a basic member.

In this type of organic photoreceptor, a “function separate photoreceptor” in which functions of generating and moving negative charges are shared by separate compounds has been becoming mainstream because there is much room for material selection and characteristics of the photoreceptor are easy to control. For example, there has been known a single-layered electrophotographic photoreceptor (hereinafter, referred to as a “single-layered photoreceptor”) with a charge generation material (CGM) and a charge transport material (CTM) in the same layer, and a multi-layered electrophotographic photoreceptor (hereinafter, referred to as a multi-layered photoreceptor) in which a charge generation layer containing a charge generation material (CGM) and a charge transport layer containing a charge transport material (CTM) are laminated. Examples of a charging method for a photoreceptor include a negative charging method by which a photoreceptor surface is negatively charged and a positive charging method by which a photoreceptor surface is positively charged.

Examples of a combination of a layer configuration and a charging method of a photoreceptor currently in practical use include a “negatively charged multi-layered photoreceptor” and a “positively charged single-layered photoreceptor”.

The “negatively charged multi-layered photoreceptor” generally has a configuration in which an undercoat layer (UCL) made of a resin, and the like is provided on a conductive support such as an aluminum tube, and a charge generation layer (CGL) made of a charge generation material (CGM), a resin, and the like is provided thereon, and a charge transport layer (CTL) made of a hole transport material (HTM), a resin, and the like is further provided thereon.

In the case of such a negatively charged multi-layered photoreceptor, the photoreceptor surface is negatively charged by a corona discharging method or a contact method, and then the photoreceptor is exposed to light. The charge generation material (CGM) absorbs the light to generate charge carriers of holes and electrons, of which the holes, i.e., positive charge carriers, are moved inside the charge transport layer (CTL) through the hole transport material (HTM) and reach the photosensitive layer surface to neutralize the surface charge. On the other hand, the electrons, i.e., negative charge carriers, generated in the charge generation material (CGM) pass through the undercoat layer (UCL) to reach the substrate. In this way, in the negatively charged multi-layered photoreceptor, it is the holes that mainly move in the photosensitive layer. Therefore, the photosensitive layer generally contains only a hole transport material as a charge transport material.

On the other hand, the “positively charged single-layered photoreceptor” generally has a configuration in which an undercoat layer (UCL) made of a resin, and the like is provided on a conductive support such as an aluminum tube, and a single-layer photosensitive layer made of a charge generation material (CGM), a hole transport material (HTM), an electron transport material (ETM), a resin, and the like is provided thereon (see, for example, PTL 1).

In the case of such a positively charged single-layered photoreceptor, the photoreceptor surface is positively charged by a corona discharging method or a contact method, and then the photoreceptor is exposed to light. The charge generation material (CGM) in the vicinity of the photosensitive layer surface absorbs the light to generate charge carriers of holes and electrons, of which the electrons, i.e., negative charge carriers, neutralize the surface charge on the photosensitive layer surface. On the other hand, holes, i.e., positive charge carriers generated in the charge generation material (CGM), pass through the photosensitive layer and the undercoat layer (UCL) to reach the substrate.

In any of the photoreceptors, the surface charge of the photoreceptor is neutralized, an electrostatic latent image is formed by a potential difference with a surrounding surface, and thereafter, the latent image is visualized with a toner (powder colored resin ink), and the toner is transferred to paper or the like and heat-melted and fixed to complete printing.

As described above, the electrophotographic photoreceptor includes, as a basic configuration, a conductive support and a photosensitive layer formed on the conductive support, and further includes a protective layer provided on the photosensitive layer for the purpose of improving abrasion resistance and the like.

For example, PTL 1 discloses that a surface protective layer containing a thermoplastic alcohol-soluble resin as a binder resin and a filler having an average primary particle diameter of 0.1 μm to 3 μm and a density of 3.0 g/cm³ or less is provided as an outermost surface layer on a photosensitive layer.

PTL 2 discloses that a crosslinked surface layer containing a trimethylolpropane acrylate crosslinked product, an organosilica cured film, and a thermosetting or photocurable crosslinked product is provided on a photosensitive layer.

Further, PTL 3 discloses that a surface protective layer is provided on a front surface side of a photosensitive layer, and the surface protective layer is a cured product obtained by photocuring a composition containing a hindered amine compound, a binder polymerizable compound, and a charge transport agent.

### CITATION LIST

### Patent Literature

PTL 1: JP 2014-163984 A
PTL 2: JP 2008-26689 A
PTL 3: JP 2019-35856 A

### SUMMARY OF INVENTION

### Technical Problem

With respect to a photoreceptor including a cured resin-based protective layer, the higher the curing degree of the protective layer, the higher the performance such as abrasion resistance. Therefore, when the protective layer is cured by, for example, photocuring, it has been common practice to increase a light emitting amount, such as by increasing a light emitting intensity, to increase the curing degree.

However, as a result of studies by the present inventors, it has been found that when the light emitting amount is too high, the photosensitive layer is damaged, for example, the hole transport material (HTM) in the photosensitive layer is decomposed by the irradiation light, so that among electrical characteristics of the photoreceptor, particularly, strong exposure characteristics (electrical characteristics after exposure to a fluorescent lamp) and transfer repeatability are deteriorated.

An object of a first embodiment according to the present invention is to provide a novel electrophotographic photoreceptor including a cured resin-based protective layer with a high curing degree, which has good initial electrical characteristics, excellent strong exposure characteristics, and excellent transfer repeatability.

On the other hand, an object of a second embodiment according to the present invention is to provide a novel electrophotographic photoreceptor including a cured resin-based protective layer, which has good initial electrical characteristics, excellent strong exposure characteristics, and excellent transfer repeatability.

### Solution to Problem

The first embodiment according to the present invention provides an electrophotographic photoreceptor including: a conductive support; and a photosensitive layer and a protective layer containing a cured product obtained by curing a curable compound, which are sequentially provided on the conductive support. An area ratio A/B is 0.0045 or less, where A is an absorbance area at a wavelength of 1647 cm⁻¹ to 1627 cm⁻¹ and B is an absorbance area of a peak at a wavelength of 1800 cm⁻¹ to 1647 cm⁻¹ in an infrared absorption spectrum measurement of the protective layer. The photosensitive layer contains at least a hole transport material (HTM) and a radical acceptor compound.

The second embodiment according to the present invention provides an electrophotographic photoreceptor including: a conductive support; and a photosensitive layer and a protective layer containing a cured product obtained by curing a curable compound, which are sequentially provided on the conductive support. The photosensitive layer contains at least a hole transport material (HTM) and a radical acceptor compound. A content of the radical acceptor compound in the photosensitive layer is 0.1 part by mass or more and 10 parts by mass or less with respect to 100 parts by mass of the hole transport material (HTM).

That is, a gist of the present invention lies in the following [1] to [16].

[1] An electrophotographic photoreceptor including:

a conductive support; and

a photosensitive layer and a protective layer containing a cured product obtained by curing a curable compound, which are sequentially provided on the conductive support, in which

an area ratio A/B is 0.0045 or less, where A is an absorbance area at a wavelength of 1647 cm⁻¹ to 1627 cm⁻¹ and B is an absorbance area of a peak at a wavelength of 1800 cm⁻¹ to 1647 cm⁻¹ in an infrared absorption spectrum measurement of the protective layer, and the photosensitive layer contains at least a hole transport material (HTM) and a radical acceptor compound.

[2] The electrophotographic photoreceptor according to [1], in which the photosensitive layer contains the radical acceptor compound at a proportion of 0.1 part by mass to 10 parts by mass with respect to 100 parts by mass of the hole transport material (HTM).

[3] An electrophotographic photoreceptor including:

a conductive support; and

a photosensitive layer and a protective layer containing a cured product obtained by curing a curable compound, which are sequentially provided on the conductive support, in which

the photosensitive layer contains at least a hole transport material (HTM) and a radical acceptor compound, and

a content of the radical acceptor compound in the photosensitive layer is 0.1 part by mass or more and 10 parts by mass or less with respect to 100 parts by mass of the hole transport material (HTM).

[4] The electrophotographic photoreceptor according to any one of [1] to [3], in which

the hole transport material (HTM) and the radical acceptor compound are contained in a same layer.

[5] The electrophotographic photoreceptor according to any one of [1] to [4], in which

the curable compound is a photocurable compound.

[6] The electrophotographic photoreceptor according to any one of [1] to [5], in which

an energy difference between a HOMO level and a LUMO level of the radical acceptor compound is 1.8 eV or more and 3.0 eV or less.

[7] The electrophotographic photoreceptor according to any one of [1] to [6], in which

an energy difference between a HOMO level and a LUMO level of the hole transport material (HTM) is larger than the energy difference between the HOMO level and the LUMO level of the radical acceptor compound.

[8] The electrophotographic photoreceptor according to [7], in which

the energy difference between the HOMO level and the LUMO level of the hole transport material (HTM) is 3.6 eV or less.

[9] The electrophotographic photoreceptor according to any one of [1] to [8], in which

the photosensitive layer is a multi-layered photosensitive layer obtained by laminating a charge generation layer and a charge transport layer in this order.

[10] The electrophotographic photoreceptor according to any one of [1] to [9], in which

the protective layer contains inorganic particles at a proportion of 0 part by mass or more and 20 parts by mass or less with respect to 100 parts by mass of the protective layer.

[11] The electrophotographic photoreceptor according to any one of above [1] to [10], in which

the hole transport material (HTM) in the photosensitive layer is a compound having a triphenylamine structure.

[12] The electrophotographic photoreceptor according to any one of above [1] to [11], in which

the radical acceptor compound in the photosensitive layer is a compound having a diphenoquinone structure or a dinaphthylquinone structure.

[13] The electrophotographic photoreceptor according to any one of above [1] to [12], in which

the protective layer is a layer formed of a composition containing the curable compound and a polymerization initiator.

[14] The electrophotographic photoreceptor according to any one of above [1] to [13], in which

the protective layer is a layer cured by irradiation with ultraviolet light and/or visible light.

[15] A cartridge including:

the electrophotographic photoreceptor according to any one of above [1] to [14].

[16] An image forming device including:

the electrophotographic photoreceptor according to any one of above [1] to [14].

### Advantageous Effects of Invention

The photoreceptor provided in the first embodiment according to the present invention includes a cured resin-based protective layer with a high curing degree, and has good initial electrical characteristics, excellent strong exposure characteristics, and excellent transfer repeatability.

The photoreceptor provided in the second embodiment according to the present invention includes a cured resin-based protective layer, and has good initial electrical characteristics, excellent strong exposure characteristics, and excellent transfer repeatability.

The photoreceptors provided in the first embodiment according to the present invention and the second embodiment according to the present invention each contain the hole transport material (HTM) and the radical acceptor compound in the photosensitive layer. In order to increase the curing degree of the protective layer, for example, the photosensitive layer contains the hole transport material (HTM) and the radical acceptor compound even when the light emitting amount during photopolymerization of the protective layer is increased. Therefore, due to the presence of the radical acceptor compound, the decomposition of the HTM can be prevented, damage to the photosensitive layer can be prevented, and excellent strong exposure characteristics and excellent transfer repeatability can be obtained.

Further, when a radical acceptor compound whose energy difference between the HOMO level and the LUMO level is 1.8 eV or more and 3.0 eV or less is used as the radical acceptor compound, particularly, the strong exposure characteristics can be further enhanced due to excellent light-shielding ability.

### BRIEF DESCRIPTION OF DRAWINGS

FIG. 1 is a diagram schematically showing a configuration example of an image forming device including an electrophotographic photoreceptor according to an embodiment of the present invention.

FIG. 2 is a graph showing a load curve with respect to an indentation depth of an indenter when measuring a Martens hardness and an elastic deformation ratio of a photoreceptor.

### DESCRIPTION OF EMBODIMENTS

Next, the present invention will be described based on an example of an embodiment. However, the present invention is not limited to the embodiments described below.

<<Present Electrophotographic Photoreceptor>>

An electrophotographic photoreceptor according to one example of a first embodiment of the present invention and a second embodiment of the present invention (referred to as “the present electrophotographic photoreceptor” or “the present photoreceptor”) is an electrophotographic photoreceptor including: a conductive support; and a photosensitive layer and a cured resin-based protective layer containing a cured product (also referred to as “the present protective layer”), which are sequentially provided on the conductive support.

The present photoreceptor may include any layer other than the photosensitive layer and the present protective layer.

A charging method for the present photoreceptor may be either a negative charging method by which a photoreceptor surface is negatively charged or a positive charging method by which a photoreceptor surface is positively charged. Among them, in terms of further obtaining the effects of the present invention, a negatively charged electrophotographic photoreceptor is preferred.

In the photoreceptor according to the present invention, a side opposite to the conductive support is an upper side or a front surface side, and a conductive support side is a lower side or a back surface side.

<Photosensitive Layer>

The photosensitive layer in the present photoreceptor may be a layer containing at least a charge generation material (CGM), a hole transport material (HTM), and a radical acceptor compound.

The photosensitive layer in the present photoreceptor may be a single-layered photosensitive layer with the charge generation material (CGM), the hole transport material (HTM), and the radical acceptor compound in the same layer, or may be a multi-layered photosensitive layer separated into a charge generation layer and a charge transport layer. Among them, a multi-layered photosensitive layer described below is more preferred.

<Multi-Layered Photosensitive Layer>

Examples of the multi-layered photosensitive layer in the present photoreceptor include a multi-layered photosensitive layer obtained by laminating a charge generation layer (CGL) and a charge transport layer (CTL) in this order, for example, a configuration in which a charge transport layer (CTL) containing a radical acceptor compound and a hole transport material (HTM) is laminated on a charge generation layer (CGL) containing a charge generation material (CGM).

In this case, a layer other than the charge generation layer (CGL) and the charge transport layer (CTL) may also be provided.

<Charge Generation Layer (CGL)>

The charge generation layer generally contains the charge generation material (CGM) and a binder resin.

(Charge Generation Material (CGM))

Examples of the charge generation material include an inorganic photoconductive material such as selenium, an alloy thereof, and cadmium sulfide, and an organic photoconductive material such as an organic pigment. Among them, an organic photoconductive material is preferred, and an organic pigment is particularly preferred.

Examples of the organic pigment include phthalocyanine, azo, and perylene. Among them, phthalocyanine or azo is particularly preferred. Among them, phthalocyanine is most preferred. Each of these compounds shows a skeleton structure of a compound, and includes a group of compounds having such a skeleton structure, i.e., a derivative.

In the case of using an organic pigment as the charge generation material, the organic pigment is generally used in a form of a dispersion layer in which fine particles thereof are bound with various binder resins.

Specific examples of the phthalocyanine include metal-free phthalocyanines, those having respective crystal forms of phthalocyanines to which a metal such as copper, indium, and gallium, or an oxide, a halide, a hydroxide, and an alkoxide of the above metal is coordinated, and phthalocyanine dimers. In particular, X-form and τ-form metal-free phthalocyanines, A-form (also known as β-form), B-form (also known as α-form), and D-form (also known as Y-form) titanyl phthalocyanines (also known as oxytitanium phthalocyanines), II-form chlorogallium phthalocyanine, and V-form hydroxygallium phthalocyanine, which have high sensitivity, are suitable.

Among the phthalocyanines, particularly preferred are A-form (O-form) and B-form (α-form) titanyl phthalocyanines, D-form (Y-form) titanyl phthalocyanine characterized by having a clear peak at a diffraction angle 20 (±0.2°) of 27.1° or 27.3° in powder X-ray diffraction, II-form chlorogallium phthalocyanine, V-form hydroxygallium phthalocyanine and hydroxygallium phthalocyanine characterized by having a strongest peak at 28.1°, or having a clear peak at 28.10 without having a peak at 26.2°, and having a half-value width W of 0.1°≤W≤0.4° at 25.9°, and X-form metal-free phthalocyanine.

A single phthalocyanine compound may be used alone, or a mixture of several phthalocyanine compounds or a phthalocyanine compound in a mixed-crystal state may be used. As a mixture of several phthalocyanine compounds or a phthalocyanine compound in a mixed-crystal state here, the respective components may be mixed later, or may be mixed in phthalocyanine compound production and treatment steps such as synthesis, pigmentization, and crystallization.

A particle diameter of the charge generation material is generally 1 μm or less, and preferably 0.5 μm or less.

(Binder Resin)

The binder resin used in the charge generation layer can be used without any particular limitation. Examples thereof include: a polyvinyl butyral resin, a polyvinyl formal resin, and a polyvinyl acetal-based resin; insulating resins such as a polyarylate resin, a polycarbonate resin, a polyester resin, a polyvinyl acetate resin, a polyamide resin, a polyurethane resin, a polyvinyl alcohol resin, and a silicon-alkyd resin; and organic photoconductive polymers such as poly-N-vinylcarbazole. Among the resins, a polyvinyl acetal resin or a polyvinyl acetate resin is preferred in terms of pigment dispersibility, adhesion to the conductive support or the undercoat layer, and adhesion to the charge transport layer.

Any one kind of the binder resins may be used alone, or two or more kinds thereof may be mixed and used in any combination.

(Other Components)

The charge generation layer may contain other components, if necessary, in addition to the charge generation material and the binder resin. For example, the charge generation layer may contain additive agents such as an antioxidant, a plasticizer, an ultraviolet absorber, an electron-attracting compound, a leveling agent, a visible light shielding agent, and a filler, which are well known, for the purpose of improving film formability, flexibility, coatability, contamination resistance, gas resistance, light resistance, and the like.

(Blending Ratio)

In the charge generation layer, as a blending ratio (mass) of the charge generation material to the binder resin, a content of the charge generation material is preferably 10 parts by mass or more, and more preferably 30 parts by mass or more, and is preferably 1000 parts by mass or less, more preferably 500 parts by mass or less, and from the viewpoint of film strength, even more preferably 300 parts by mass or less, and still more preferably 200 parts by mass or less, with respect to 100 parts by mass of the binder resin.

(Layer Thickness)

A thickness of the charge generation layer is preferably 0.1 μm or more, and more preferably 0.15 μm or more. On the other hand, the thickness is preferably 1.0 μm or less, and more preferably 0.6 μm or less.

<Charge Transport Layer (CTL)>

The charge transport layer (CTL) generally contains the radical acceptor compound, the hole transport material (HTM), and a binder resin.

(Hole Transport Material (HTM))

The hole transport material (HTM) contained in the photosensitive layer is not particularly limited, and when an energy difference between a HOMO level and a LUMO level of the hole transport material (HTM) is larger than an energy difference between a HOMO level and a LUMO level of the radical acceptor compound to be described later, the effects of the present invention are more significantly exhibited.

When the energy difference of the hole transport material (HTM) is larger than that of the radical acceptor compound, the radical acceptor compound preferentially absorbs energy of irradiation light over the hole transport material (HTM) when the present photoreceptor receives the irradiation light for curing the protective layer. Therefore, the effects of the present invention can be further obtained due to coexistence of the radical acceptor compound.

When a plurality of kinds of radical acceptor compounds are used in the photosensitive layer, the energy difference of the radical acceptor compound having a large number of parts by mass is used as a reference.

Further, when the energy difference between the HOMO level and the LUMO level of the hole transport material (HTM) is 3.6 eV or less, particularly 3.60 eV or less, the effects of the present invention are further more remarkably exhibited.

When the energy difference is greater than 3.6 eV, the ability to absorb light having a wavelength longer than 344 nm is reduced. The irradiation light for curing the protective layer generally has a wavelength of 360 nm or longer from the viewpoint of cost and the like in the case of LED light, and a proportion of light having a wavelength shorter than 350 nm is small in the case of metal halide light. Therefore, it is considered that the HTM whose energy difference is greater than 3.6 eV is less damaged by the irradiation light. On the other hand, when the energy difference of the hole transport material (HTM) is 3.6 eV or less, particularly 3.60 eV or less, the hole transport material (HTM) is easily damaged by the irradiation light, so that the effects of the present invention can be further obtained due to coexistence of a predetermined radical acceptor compound.

From such a viewpoint, the energy difference of the hole transport material (HTM) is more preferably 3.5 eV or less, particularly 3.50 eV or less. Among them, the energy difference of the hole transport material (HTM) is particularly preferably 3.35 eV or less, and even more preferably 3.20 eV or less.

Examples of the hole transport material (HTM) whose energy difference between the HOMO level and the LUMO level is 3.6 eV or less and larger than the energy difference between the HOMO level and the LUMO level of the radical acceptor compound to be described later include heterocyclic compounds such as a carbazole derivative, an indole derivative, an imidazole derivative, an oxazole derivative, a pyrazole derivative, a thiadiazole derivative, and a benzofuran derivative, an aniline derivative, a hydrazone derivative, an aromatic amine derivative, an arylamine derivative, a stilbene derivative, a butadiene derivative, an enamine derivative, and compounds each made of two or more kinds of these compounds bonded together.

Compounds corresponding to the above energy levels (the HOMO level and the LUMO level) may be appropriately selected from these compounds. Two or more kinds of compounds corresponding to the above energy levels may be used in combination.

In the present invention, the HOMO energy level (E_homo) and the LUMO energy level (E_lumo) can be obtained by determining a stable structure by structural optimization calculation using B3LYP (see A. D. Becke, J. Chem. Phys. 98, 5648 (1993), C. Lee, et. al., Phys. Rev. B37, 785 (1988), and B. Miehlich, et. al., Chem. Phys. Lett. 157, 200 (1989)), which is a kind of density functional theory method.

At this time, 6-31G (d, p) obtained by adding a polarization function to 6-31G is used as a basis function (see R. Ditchfield, et. al., J. Chem. Phys. 54, 724 (1971), W. J. Hehre, et. al., J. Chem. Phys. 56, 2257 (1972), P. C. Hariharan et. al., Mol. Phys. 27, 209 (1974), M. S. Gordon, Chem. Phys. Lett. 76, 163 (1980), P. C. Hariharan et. al., Theo. Chim. Acta 28, 213 (1973), J.-P. Blaudeau, et. al., J. Chem. Phys. 107, 5016 (1997), M. M. Francl, et. al., J. Chem. Phys. 77, 3654 (1982), R. C. Binning, Jr. et. al., J. Comp. Chem. 11, 1206 (1990), V. A. Rassolov, et. al., J. Chem. Phys. 109, 1223 (1998), and V. A. Rassolov, et. al., J. Comp. Chem. 22, 976 (2001)).

In the present invention, the B3LYP calculation using 6-31G (d, p) is described as B3LYP/6-31G (d, p).

In the present invention, a program used for the B3LYP/6-31G (d, p) calculation is Gaussian 03, Revision D. 01 (M. J. Frisch, et. al., Gaussian, Inc., Wallingford Conn., 2004.).

The hole transport material (HTM) is preferably a material having high hole mobility. From this viewpoint, the hole transport material (HTM) is preferably a compound having a triphenylamine structure.

Suitable examples of the hole transport materials (HTM) include compounds each having any of structures represented by the following general formulae. The present invention is not limited thereto. Any one kind of these hole transport materials may be used alone, or two or more kinds thereof may be used in any combination.

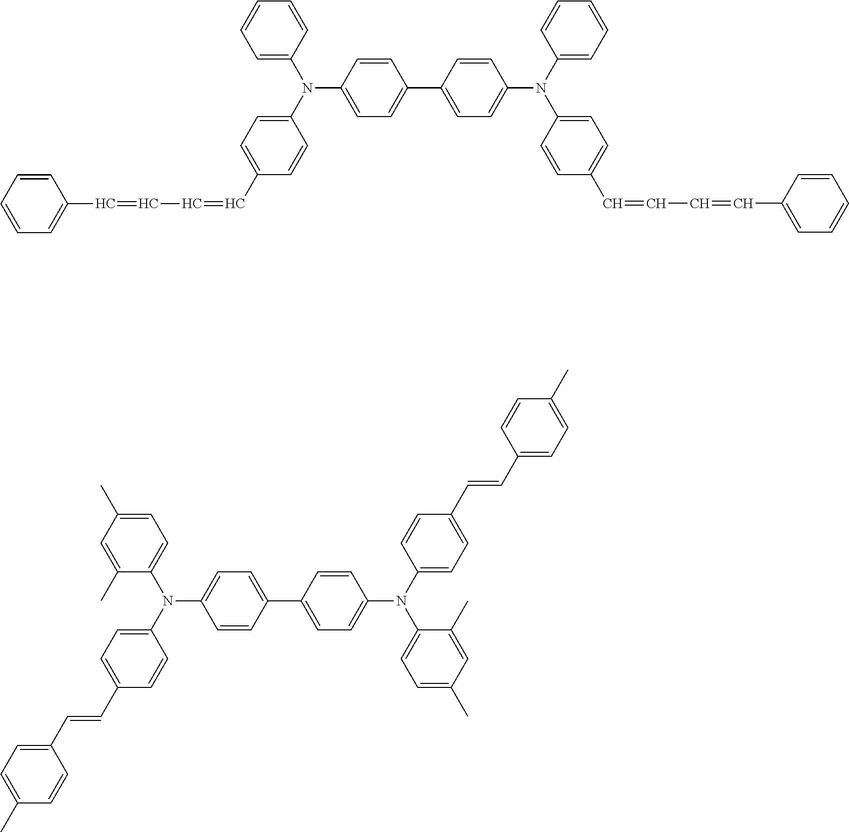

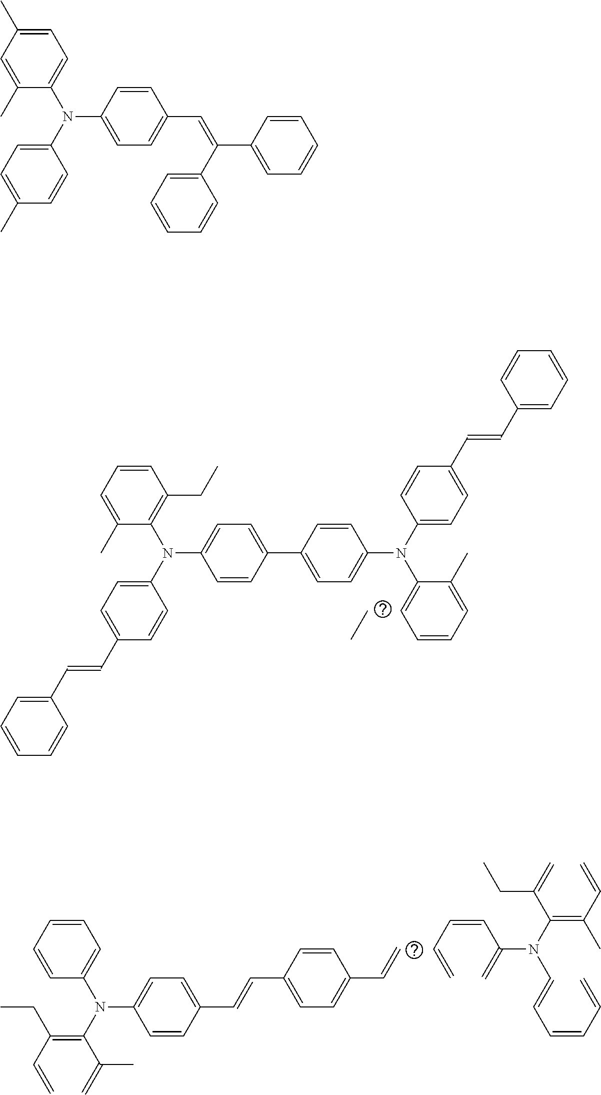

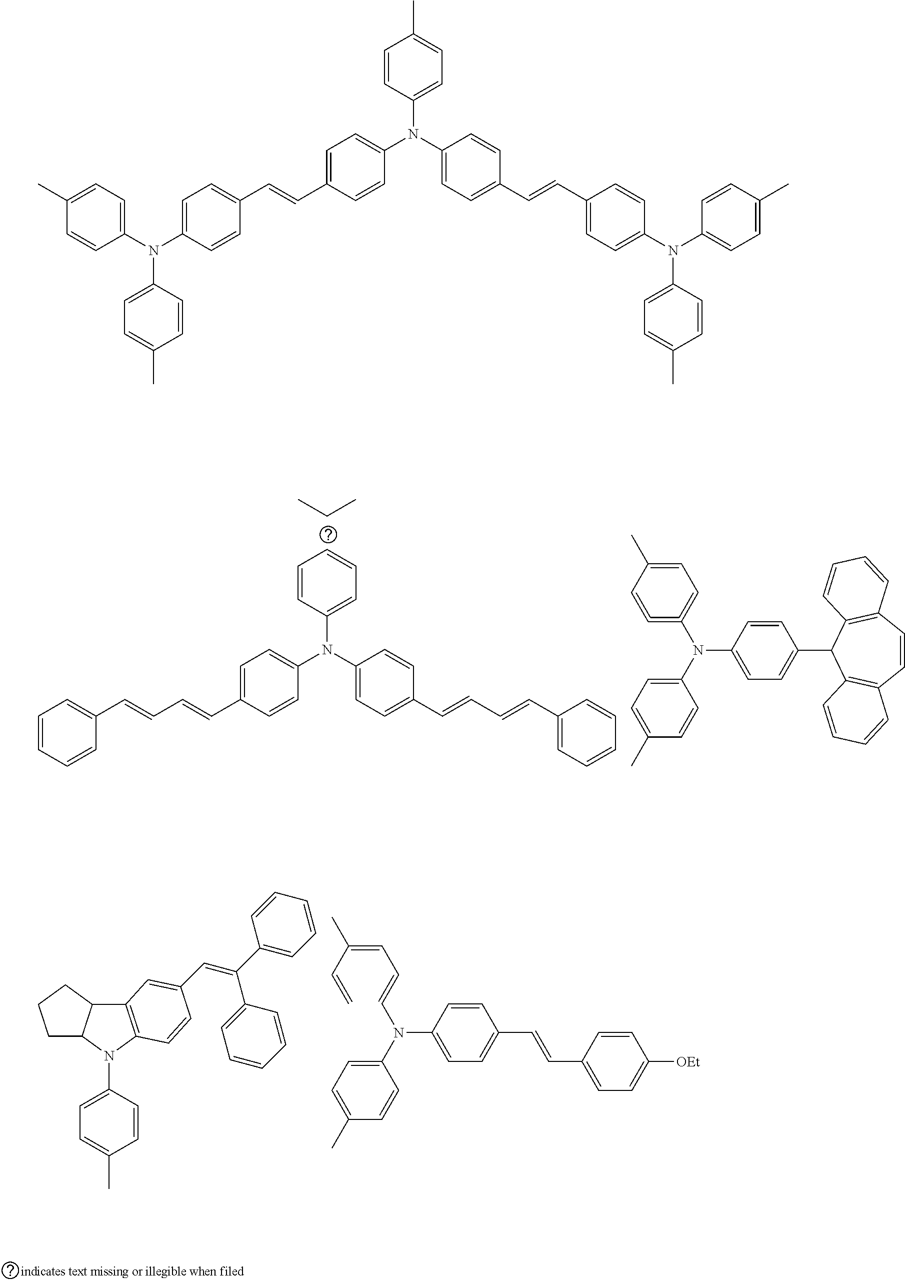

(Radical Acceptor Compound)

In the present invention, the term “radical acceptor compound” means a compound having a property of being able to accept a radical from the hole transport material (HTM), more specifically, a compound having an electron affinity of 3.5 eV or more.

Here, the electron affinity means energy generated when a certain substance absorbs one electron, and can be obtained by determining a stable structure by structural optimization calculation using B3LYP (see A. D. Becke, J. Chem. Phys. 98, 5648 (1993), C. Lee, et. al., Phys. Rev. B37, 785 (1988) and B. Miehlich, et. al., Chem. Phys. Lett. 157, 200 (1989)), which is a kind of the density functional theory method described above. In determining the electron affinity, a basis function and a program used for calculation can be the same as those described above.

In order to increase the curing degree of the protective layer, for example, even when the light emitting amount during photopolymerization of the protective layer is increased the present photosensitive layer contains the radical acceptor compound and the hole transport material (HTM). Therefore, due to the presence of the radical acceptor compound, the decomposition of the HTM and the likes can be prevented, damage to the photosensitive layer can be prevented, and excellent strong exposure characteristics and excellent transfer repeatability can be obtained.

The reason for this is presumed as follows.

When forming a cured resin-based protective layer, it is common for curing to proceed due to involvement of a radical from a polymerization initiator or the like. Therefore, the radical also propagates to the hole transport material (HTM) in the photosensitive layer, and an HTM radical is likely to be generated. In general, a compound in a radical state is more active than a compound in a normal state, so that it is considered that a compound in a radical state is more likely to be photodecomposed by light from a fluorescent lamp, and the like. That is, it is presumed that, in the photoreceptor including a cured resin-based protective layer, the HTM is radicalized and further photodecomposed, which makes it impossible to exhibit the hole transporting property, and as a result, electrical characteristics such as strong exposure characteristics and transfer repeatability are deteriorated.

Here, it is considered that in the case where the photosensitive layer contains not only the hole transport material (HTM) but also the radical acceptor compound, even when the HTM radical is generated, the HTM radical is immediately converted to the HTM by extracting a hydrogen atom from the radical acceptor compound, while the radical acceptor compound is converted to a radical.

Therefore, it is considered that when the photosensitive layer contains the HTM and the radical acceptor compound, the HTM can be prevented from being radicalized and photodecomposed, the strong exposure characteristics, and the transfer repeatability can be improved, as compared with the case where the photosensitive layer contains the HTM alone.

In the case where the photosensitive layer contains not only the hole transport material (HTM) but also an electron transport material (ETM) to be described later, the ETM is more likely to be radicalized than the HTM, so that even when an HTM radical is generated, the HTM radical immediately extracts a hydrogen atom from the ETM and is converted into the HTM, whereby excellent strong exposure characteristics and excellent transfer repeatability can be obtained. Considering the action mechanism, all the electron transport materials (ETM) are encompassed by the “radical acceptor compound”, and it is considered that even when the electron transport material (ETM) is used, the effect of improving the strong exposure characteristics and the transfer repeatability can be obtained due to the action mechanism same as that of the radical acceptor compound.

The energy difference between the HOMO level and the LUMO level of the radical acceptor compound that can be used in the present photoreceptor is preferably 1.8 eV or more and 3.0 eV or less.

When the energy difference of the radical acceptor compound is 1.8 eV or more, the radical acceptor compound does not absorb general exposure light having 780 nm or the like, and sensitivity is less likely to decrease. On the other hand, when the energy difference of the radical acceptor compound is 3.0 eV or less, the radical acceptor compound preferentially absorbs light having a wavelength that can damage the hole transport material (HTM) than the hole transport material (HTM), and the damage to the hole transport material (HTM) can be prevented.

From such a viewpoint, the energy difference of the radical acceptor compound is preferably 1.8 eV or more, more preferably 2.0 eV or more, and even more preferably 2.2 eV or more, and on the other hand, the energy difference is preferably 3.0 eV or less, more preferably 2.8 eV or less, even more preferably 2.6 eV or less, and particularly preferably 2.4 eV or less.

The method for measuring the energy of the HOMO level and the LUMO level in the radical acceptor compound is the same as that for the hole transport material (HTM).

The electron affinity of the radical acceptor compound is preferably 3.5 eV or more, particularly 3.50 eV or more, more preferably 3.7 eV or more, particularly 3.70 eV or more, and even more preferably 3.8 eV or more, particularly 3.80 eV or more, since the effects of the present invention can be further obtained. On the other hand, the electron affinity of the radical acceptor compound is preferably 4.3 eV or less, particularly 4.30 eV or less, more preferably 4.1 eV or less, particularly 4.10 eV or less, even more preferably 4.0 eV or less, particularly 4.00 eV or less, and particularly preferably 3.9 eV or less, particularly 3.90 eV or less.

Preferred embodiments of the electron transport material (ETM) to be described later can similarly be applied to preferred embodiments of the radical acceptor compound.

The radical acceptor compound can be selected from electron transport materials (ETM) described below. Compounds other than the compounds exemplified as the electron transport material (ETM) can also be used. Further, the compounds exemplified as the electron transport material (ETM) can be used in combination with other compounds.

A content of the radical acceptor compound in the photosensitive layer of the present photoreceptor is preferably 0.1 part by mass or more, more preferably 0.3 part by mass or more, even more preferably 0.5 part by mass or more, and particularly preferably 0.7 part by mass or more, with respect to 100 parts by mass of the hole transport material (HTM) in the photosensitive layer. On the other hand, the content is preferably 10 parts by mass or less, more preferably 7.0 parts by mass or less, even more preferably 5.0 parts by mass or less, still more preferably 3.0 parts by mass or less, even still more preferably 2.0 parts by mass or less, and particularly preferably 1.5 parts by mass or less, with respect to 100 parts by mass of the hole transport material (HTM) in the photosensitive layer.

A content of the radical acceptor compound in the charge transport layer (CTL) of the present photoreceptor (a content with respect to 100 parts by mass of the hole transport material in the charge transport layer) is the same as the content of the radical acceptor compound in the photosensitive layer (the content with respect to 100 parts by mass of the hole transport material in the charge transport layer).

A molar ratio of the radical acceptor compound to the hole transport material (HTM) in the photosensitive layer of the present photoreceptor (a molar amount of the radical acceptor compound/a molar amount of the hole transport material) is preferably 0.01 or more, and more preferably 0.02 or more. On the other hand, the molar ratio is preferably 0.1 or less, more preferably 0.05 or less, and even more preferably 0.03 or less.

(Electron Transport Material (ETM))

As described above, the present photoreceptor may contain the hole transport material (HTM) and the electron transport material (ETM) in the photosensitive layer.

An energy difference between a HOMO level and a LUMO level of the electron transport material (ETM) that can be used in the present photoreceptor is preferably 1.8 eV or more and 3.0 eV or less.

When the energy difference of the electron transport material (ETM) is 1.8 eV or more, the electron transport material (ETM) does not absorb general exposure light having 780 nm or the like, and the sensitivity is less likely to decrease. On the other hand, when the energy difference of the electron transport material (ETM) is 3.0 eV or less, the electron transport material (ETM) preferentially absorbs light having a wavelength that can damage the hole transport material (HTM) over the hole transport material (HTM), and the damage to the hole transport material (HTM) can be prevented.

From such a viewpoint, the energy difference of the electron transport material (ETM) is preferably 1.8 eV or more, more preferably 2.0 eV or more, and even more preferably 2.2 eV or more, and on the other hand, the energy difference is preferably 3.0 eV or less, more preferably 2.8 eV or less, and even more preferably 2.6 eV or less.

The method for measuring the energy of the HOMO level and the LUMO level in the electron transport material (ETM) is the same as that for the hole transport material (HTM).

Specific examples of the electron transport material (ETM) include electron-attracting materials such as aromatic nitro compounds such as 2,4,7-trinitrofluorenone, cyano compounds such as tetracyanoquinodimethane, and quinone compounds such as diphenoquinone and dinaphthylquinone, and compounds each made of two or more of these compounds bonded together or polymers each having, in a main chain or a side chain thereof, a group constituted of any one of these compounds. The present invention is not limited thereto, and known electron transport materials can be used.

Among them, from the viewpoint of the electrical characteristics, the electron transport material (ETM) is preferably a compound having a diphenoquinone structure or a dinaphthylquinone structure. Among them, a compound having a dinaphthylquinone structure is more preferred.

Any one kind of the above electron transport materials may be used alone, or two or more kinds thereof may be used in any combination.

Specific examples of the electron transport material (ETM) that can be used in the present photoreceptor include compounds represented by general formulae (ET1) to (ET3) illustrated in paragraphs 0043 to 0053 in JP 2017-09765 A.

Specific examples of the electron transport material (ETM) include compounds each having any one of structures shown below.

The present invention is not limited thereto. Any one kind of these hole transport materials may be used alone, or two or more kinds thereof may be used in any combination.

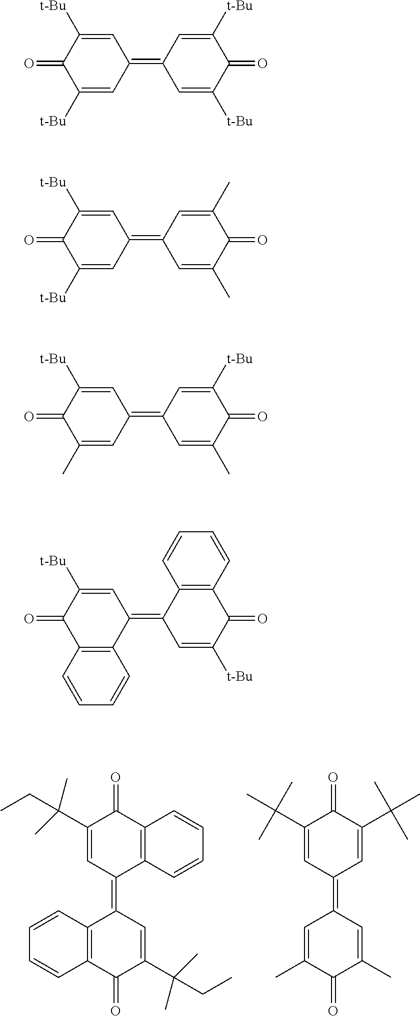

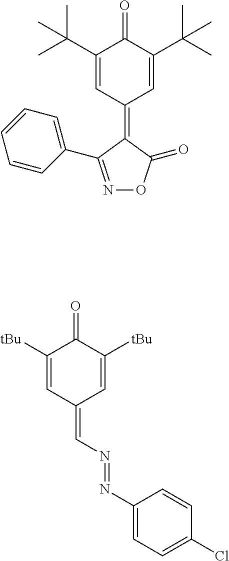 [SMILES: CC(C)(C)C1=CC(=C2C(=O)ON=C2c2ccccc2)C=C(C(C)(C)C)C1=O ; CC(C)(C)C1=CC(=C/N=N/c2ccc(Cl)cc2)C=C(C(C)(C)C)C1=O]

A content of the electron transport material (ETM) in the photosensitive layer is preferably 0.1 part by mass or more, more preferably 0.3 part by mass or more, even more preferably 0.5 part by mass or more, and particularly preferably 0.7 part by mass or more, with respect to 100 parts by mass of the hole transport material (HTM) in the photosensitive layer. On the other hand, the content is preferably 10 parts by mass or less, more preferably 7.0 parts by mass or less, even more preferably 5.0 parts by mass or less, still more preferably 3.0 parts by mass or less, even still more preferably 2.0 parts by mass or less, and particularly preferably 1.5 parts by mass or less.

A content proportion of the hole transport material (HTM) to the electron transport material (ETM) in the present photoreceptor is the same as the content proportion of the hole transport material (HTM) to the electron transport material (ETM) in the photosensitive layer described above.

A content proportion of the hole transport material (HTM) to the electron transport material (ETM) in the charge transport layer (CTL) is the same as the content proportion of the hole transport material (HTM) to the electron transport material (ETM) in the photosensitive layer described above.

(Binder Resin)

Examples of the binder resin in the charge transport layer include thermoplastic resins and various thermosetting compounds such as polymethyl methacrylate, polystyrene, vinyl polymers such as polyvinyl chloride and copolymers thereof, polycarbonates, polyarylates, polyesters, polyester polycarbonates, polysulfones, phenoxy, epoxy, and a silicone resin. Among the resins, a polycarbonate resin or a polyarylate resin is preferred in terms of light attenuation characteristics and mechanical strength of the photoreceptor.

The binder resin has a viscosity average molecular weight (Mv) of generally 5,000 to 300,000, preferably 10,000 to 200,000, more preferably 15,000 to 150,000, and particularly preferably 20,000 to 80,000.

As for a blending proportion of the hole transport material (HTM) to the binder resin constituting the photosensitive layer, the hole transport material (HTM) is generally blended in a proportion of 20 parts by mass or more with respect to 100 parts by mass of the binder resin. Among them, the hole transport material (HTM) is preferably blended in a proportion of 30 parts by mass or more with respect to 100 parts by mass of the binder resin from the viewpoint of reducing a residual potential, and the hole transport material (HTM) is more preferably blended in a proportion of 40 parts by mass or more from the viewpoint of stability and charge mobility during repeated use. On the other hand, the hole transport material (HTM) is preferably blended in a proportion of 200 parts by mass or less with respect to 100 parts by mass of the binder resin from the viewpoint of thermal stability of the photosensitive layer, the hole transport material (HTM) is more preferably blended in a proportion of 150 parts by mass or less from the viewpoint of compatibility between the hole transport material (HTM) and the binder resin, and the hole transport material (HTM) is particularly preferably blended in a proportion of 120 parts by mass or less from the viewpoint of a glass transition temperature. When the hole transport material (HTM) is blended in a proportion of 120 parts by mass or less, the glass transition temperature of the photosensitive layer increases, and an improvement in leak resistance can be expected.

A blending proportion of the hole transport material (HTM) to the binder resin constituting the charge transport layer is the same as the blending proportion of the hole transport material (HTM) to the binder resin in the photosensitive layer described above.

As for a content proportion of the hole transport material (HTM) to a total mass of the photosensitive layer, the hole transport material (HTM) is generally blended in a proportion of 16 parts by mass or more with respect to 100 parts by mass of the photosensitive layer. Among them, the hole transport material (HTM) is preferably blended in a proportion of 22 parts by mass or more with respect to 100 parts by mass of the photosensitive layer from the viewpoint of reducing the residual potential, and further the hole transport material (HTM) is more preferably blended in a proportion of 28 parts by mass or more from the viewpoint of stability and charge mobility during repeated use. On the other hand, the hole transport material (HTM) is preferably blended in a proportion of 68 parts by mass or less with respect to 100 parts by mass of the photosensitive layer from the viewpoint of the thermal stability of the photosensitive layer, the hole transport material (HTM) is more preferably blended in a proportion of 59 parts by mass or less from the viewpoint of uniformity of the photosensitive layer, and the hole transport material (HTM) is particularly preferably blended in a proportion of 53 parts by mass or less from the viewpoint of the glass transition temperature. When the hole transport material (HTM) is blended in a proportion of 53 parts by mass or less, the glass transition temperature of the photosensitive layer increases, and an improvement in leak resistance can be expected.

As for the blending proportion of the hole transport material (HTM) to the binder resin in the charge transport layer (CTL), the hole transport material (HTM) is preferably blended in a proportion of 20 parts by mass or more with respect to 100 parts by mass of the binder resin. Among them, the hole transport material (HTM) is more preferably blended in a proportion of 30 parts by mass or more with respect to 100 parts by mass of the binder resin from the viewpoint of reducing a residual potential, and the hole transport material (HTM) is even more preferably blended in a proportion of 40 parts by mass or more from the viewpoint of stability and charge mobility during repeated use. On the other hand, the hole transport material (HTM) is preferably blended in a proportion of 200 parts by mass or less with respect to 100 parts by mass of the binder resin from the viewpoint of thermal stability of the photosensitive layer, the hole transport material (HTM) is more preferably blended in a proportion of 150 parts by mass or less from the viewpoint of compatibility between the hole transport material (HTM) and the binder resin, and is particularly preferably blended in a proportion of 120 parts by mass or less from the viewpoint of the glass transition temperature. When the hole transport material (HTM) is blended in a proportion of 120 parts by mass or less, the glass transition temperature of the photosensitive layer increases, and an improvement in leak resistance can be expected.

(Other Components)

The charge transport layer may contain other components, if necessary, in addition to the radical acceptor compound, the hole transport material (HTM), and the binder resin. For example, the charge transport layer may contain additive agents such as an antioxidant, a plasticizer, an ultraviolet absorber, an electron-attracting compound, a leveling agent, a visible light shielding agent, and a filler, which are well known, for the purpose of improving film formability, flexibility, coatability, contamination resistance, gas resistance, light resistance, and the like.

(Layer Thickness)

A layer thickness of the charge transport layer is not particularly limited. From the viewpoint of the electrical characteristics, image stability, and high resolution, the layer thickness is preferably 5 μm or more or 50 μm or less, more preferably 10 μm or more or 35 μm or less, and even more preferably 15 μm or more or 25 μm or less.

<Single-Layered Photosensitive Layer>

Examples of the single-layered photosensitive layer in the present photoreceptor include a configuration in which a charge generation material (CGM), a hole transport material (HTM), and a radical acceptor compound are present in the same layer.

The charge generation material (CGM), the hole transport material (HTM), and the radical acceptor compound in the single-layered photosensitive layer can be the same as those in the multi-layered photosensitive layer. In addition, contents and content proportions of the respective components in the single-layered photosensitive layer are also the same as those in the multi-layered photosensitive layer.

(Method for Forming Each Layer)

Each of the above layers can be formed by applying a coating liquid, which is obtained by dissolving or dispersing materials to be contained in a solvent, onto a base layer, for example, a conductive support by a known method such as dip coating, spray coating, and bar coating, and sequentially repeating a coating and drying step for each layer. The present invention is not limited to such a forming method.

The solvent or dispersion medium used for preparing the coating liquid is not particularly limited. Specific examples thereof include alcohols such as methanol, ethers such as tetrahydrofuran, esters, ketones such as acetone and methyl ethyl ketone, aromatic hydrocarbons such as toluene, chlorinated hydrocarbons such as dichloromethane, nitrogen-containing compounds, and aprotic polar solvents. These may be used alone or in any combination of two or more kinds thereof.

An amount of the solvent or dispersion medium to be used is not particularly limited.

A coating film is preferably dried by heating in a temperature range of generally 30° C. or higher and 200° C. or lower for 1 minute to 2 hours with or without an air stream after finger touch drying at room temperature. The heating temperature may be constant, or heating may be performed while changing a temperature during drying.

<Present Protective Layer>

The present protective layer is preferably a layer containing a cured product obtained by curing a curable compound.

The present protective layer can be formed of a composition containing a curable compound and a polymerization initiator. As the curable compound, a curable compound having an acryloyl group and/or a methacryloyl group is preferred. Among them, the curable composition containing the curable compound and the polymerization initiator is preferably formed by thermally curing or photocuring, and more preferably formed by photocuring.

In the present protective layer, an area ratio A/B is preferably 0.0045 or less, where A is an absorbance area at a wavelength of 1647 cm⁻¹ to 1627 cm⁻¹ and B is an absorbance area of a peak at a wavelength of 1800 cm⁻¹ to 1647 cm⁻¹ in an infrared absorption spectrum measurement of the present protective layer.

When the area ratio A/B of the present protective layer, in other words, the absorbance ratio A/B is 0.0045 or less, the present protective layer is sufficiently cured, and excellent abrasion resistance can be obtained.

When the absorbance ratio A/B is 0.0045 or less, curing of the protective layer becomes sufficient, and deterioration of abrasion resistance can be prevented. Therefore, in the first embodiment of the present invention, which aims to increase the curing degree of the protective layer, the absorbance ratio A/B of 0.0045 or less is an essential constituent, whereas in the second embodiment of the present invention, which does not aim to increase the curing degree of the protective layer, the absorbance ratio A/B of 0.0045 or less is not an essential constituent.

From such a viewpoint, the area ratio A/B of the present protective layer is preferably 0.0045 or less, and more preferably 0.0040 or less. The lower limit of the area ratio A/B is not limited and may be 0 (zero).

In this case, the area ratio, that is, the absorbance ratio, defines a residual proportion of double bonds remaining in the protective layer, and defines the curing degree of the protective layer.

The curing degree of the protective layer can be quantified by using a ratio of an absorbance of a characteristic absorption wavelength derived from a chemical structure, i.e., a double bond (CH₂═CH—) of an acryloyl group or a methacryloyl group whose chemical structure changes before and after energy ray curing to an absorbance of a characteristic absorption wavelength derived from a chemical structure, i.e., a carbonyl bond (C═O) of an acryloyl group whose chemical structure does not change before and after energy ray curing.

Here, an absorbance at a wavelength of 1647 cm⁻¹ to 1627 cm⁻¹ is mainly derived from the double bond (C═C) of the acryloyl group or the methacryloyl group. On the other hand, an absorbance at a wavelength of 1800 cm⁻¹ to 1647 cm⁻¹ is mainly derived from the carbonyl group (C═O) of the acryloyl group or the methacryloyl group.

In the present invention, the absorbance area is obtained based on an area of an absorption peak on the baseline.

(Curing Degree)

The curing degree of the present protective layer can be calculated by obtaining values of the area ratio A/B before and after curing and substituting them into the following equation.

Curing degree=[1−[(A/B after curing)/(A/B before curing)]]×100

The curing degree of the present protective layer is preferably 70 or more, more preferably 75 or more, even more preferably 80 or more, and particularly preferably 85 or more. When the curing degree of the protective layer is 70 or more, practically sufficient abrasion resistance can be provided.

(Martens Hardness)

In the present photoreceptor, as described above, since the curing degree of the present protective layer is high, the Martens hardness of the present photoreceptor is also large. Therefore, practically sufficient abrasion resistance can be provided.

The Martens hardness of the present photoreceptor is preferably 210 N/mm² or more, more preferably 215 N/mm² or more, and more preferably 220 N/mm² or more.

In the present invention, the Martens hardness of the photoreceptor means a Martens hardness measured from a front surface side of the photoreceptor.

The Martens hardness can be measured by a method described in Examples below.

(Elastic Deformation Ratio)

In the present photoreceptor, as described above, since the curing degree of the present protective layer is high, the elastic deformation ratio of the present photoreceptor is also large. Since the elastic deformation ratio is large, practically sufficient abrasion resistance can be provided.

The elastic deformation ratio of the present photoreceptor is preferably 37.5% or more, more preferably 38.0% or more, even more preferably 39.0% or more, and particularly preferably 40.0% or more.

In the present invention, the elastic deformation ratio of the photoreceptor means an elastic deformation ratio measured from the front surface side of the photoreceptor.

The elastic deformation ratio can be measured by a method described in Examples below.

(Curable Composition)

Examples of the curable composition include a composition containing a curable compound having an acryloyl group and/or a methacryloyl group, a polymerization initiator, and if necessary, metal oxide particles and other materials.

(Curable Compound)

As the curable compound, a monomer, an oligomer, or a polymer having a radically polymerizable functional group is preferred. Among them, a curable compound having crosslinkability, particularly a photocurable compound, is preferred. Examples thereof include a curable compound having two or more radically polymerizable functional groups. A compound having one radically polymerizable functional group may be used in combination.

Examples of the radically polymerizable functional group include either an acryloyl group (including an acryloyloxy group) or a methacryloyl group (including a methacryloyloxy group), or both of them.

Preferred examples of the curable compound having a radically polymerizable functional group are shown below.

Examples of the monomer having an acryloyl group or a methacryloyl group include trimethylolpropane triacrylate (TMPTA), trimethylolpropane trimethacrylate, HPA-modified trimethylolpropane triacrylate, EO-modified trimethylolpropane triacrylate, PO-modified trimethylolpropane triacrylate, caprolactone-modified trimethylolpropane triacrylate, HPA-modified trimethylolpropane trimethacrylate, pentaerythritol triacrylate, pentaerythritol tetraacrylate, glycerol triacrylate, ECH-modified glycerol triacrylate, EO-modified glycerol triacrylate, PO-modified glycerol triacrylate, tris(acryloxyethyl) isocyanurate, caprolactone-modified tris(acryloxyethyl) isocyanurate, EO-modified tris(acryloxyethyl) isocyanurate, PO-modified tris(acryloxyethyl) isocyanurate, dipentaerythritol hexaacrylate, caprolactone-modified dipentaerythritol hexaacrylate, dipentaerythritol hydroxypentaacrylate, alkyl-modified dipentaerythritol pentaacrylate, alkyl-modified dipentaerythritol tetraacrylate, alkyl-modified dipentaerythritol triacrylate, dimethylolpropane tetraacrylate, pentaerythritol ethoxytetraacrylate, EO-modified phosphoric acid triacrylate, 2,2,5,5,-tetrahydroxymethylcyclopentanone tetraacrylate, 2-hydroxy-3-acryloyloxypropyl methacrylate, polyethylene glycol diacrylate, polypropylene glycol diacrylate, polytetramethylene glycol diacrylate, EO-modified bisphenol A diacrylate, PO-modified bisphenol A diacrylate, 9,9-bis[4-(2-acryloyloxyethoxy)phenyl]fluorene, tricyclodecanedimethanol diacrylate, decanediol diacrylate, hexanediol diacrylate, ethylene glycol dimethacrylate, polyethylene glycol dimethacrylate, EO-modified bisphenol A dimethacrylate, PO-modified bisphenol A dimethacrylate, tricyclodecanedimethanol dimethacrylate, decanediol dimethacrylate, and hexanediol dimethacrylate.

Examples of the oligomer or polymer having an acryloyl group or a methacryloyl group include a urethane acrylate, an ester acrylate, an acrylic acrylate, and an epoxy acrylate. Among them, a urethane acrylate or an ester acrylate is preferred, and an ester acrylate is more preferred.

The above compounds can be used alone or in combination of two or more kinds thereof.

(Polymerization Initiator)

Examples of the polymerization initiator include a thermal polymerization initiator and a photopolymerization initiator.

Examples of the thermal polymerization initiator include peroxide-based compounds such as 2,5-dimethylhexane-2,5-dihydroperoxide, and azo compounds such as 2,2′-azobis(isobutyronitrile).

The photopolymerization initiator can be classified into a direct cleavage type and a hydrogen abstraction type depending on a difference in a radical generation mechanism.

The direct cleavage type photopolymerization initiator generates a radical by partly cleaving a covalent bond in one molecule thereof upon absorption of light energy. On the other hand, in the hydrogen abstraction type photopolymerization initiator, a molecule in a state of being excited by absorbing light energy abstracts hydrogen from a hydrogen donor to generate a radical.

Examples of the direct cleavage type photopolymerization initiator include: acetophenone-based or ketal-based compounds such as acetophenone, 2-benzoyl-2-propanol, 1-benzoylcyclohexanol, 2,2-diethoxyacetophenone, benzyldimethylketal, and 2-methyl-4′-(methylthio)-2-morpholinopropiophenone; benzoin ether-based compounds such as benzoin, benzoin methyl ether, benzoin ethyl ether, benzoin isobutyl ether, benzoin isopropyl ether, and O-tosyl benzoin; and acylphosphine oxide-based compounds such as diphenyl(2,4,6-trimethylbenzoyl)phosphine oxide, phenylbis(2,4,6-trimethylbenzoyl)phosphine oxide, and lithium phenyl(2,4,6-trimethylbenzoyl)phosphonate.

Examples of the hydrogen abstraction type photopolymerization initiator include: benzophenone-based compounds such as benzophenone, 4-benzoylbenzoic acid, 2-benzoylbenzoic acid, methyl 2-benzoylbenzoate, methyl benzoylformate, benzyl, p-anisyl, 2-benzoylnaphthalene, 4,4′-bis(dimethylamino)benzophenone, 4,4′-dichlorobenzophenone, and 1,4-dibenzoylbenzene; and anthraquinone-based or thioxanthone-based compounds such as 2-ethylanthraquinone, 2-isopropylthioxanthone, 2-chlorothioxanthone, 2,4-dimethylthioxanthone, 2,4-diethylthioxanthone, and 2,4-dichlorothioxanthone.

Examples of other photopolymerization initiators include camphorquinone, 1-phenyl-1,2-propanedione-2-(o-ethoxycarbonyl)oxime, acridine-based compounds, triazine-based compounds, and imidazole-based compounds.

The photopolymerization initiator preferably has an absorption wavelength in a wavelength region of a light source used for light irradiation in order to efficiently absorb light energy to generate a radical. On the other hand, when a component other than the photopolymerization initiator among the compounds contained in the outermost layer has absorption in the wavelength region, the photopolymerization initiator may not absorb sufficient light energy, and the radical generation efficiency may decrease. Since general binder resins, charge transport materials, and metal oxide particles have an absorption wavelength in an ultraviolet region (UV), this effect is particularly remarkable when the light source used for light irradiation is ultraviolet light (UV). From the viewpoint of preventing such a problem, it is preferred to contain an acylphosphine oxide-based compound, which has an absorption wavelength on a relatively long wavelength side, among the photopolymerization initiator.

Since the acylphosphine oxide-based compound has a photo-bleaching effect in which the absorption wavelength region is changed to a low wavelength side due to self-cleavage, the acylphosphine oxide-based compound can transmit light to the inside of the outermost layer, and is also preferred from the viewpoint of good internal curability. In consideration of such effects, it is more preferred to use the acylphosphine oxide-based compound and the hydrogen abstraction type initiator in combination from the viewpoint of supplementing the curability of the outermost layer surface. At this time, a content proportion of the hydrogen abstraction type initiator to the acylphosphine oxide-based compound is not particularly limited, but is preferably 0.1 part by mass or more with respect to 1 part by mass of the acylphosphine oxide-based compound from the viewpoint of supplementing the surface curability, and is preferably 5 parts by mass or less from the viewpoint of maintaining the internal curability.

In addition, a compound having a photopolymerization accelerating effect may be used alone or in combination with the photopolymerization initiator. Examples of the compound having a photopolymerization accelerating effect include triethanolamine, methyldiethanolamine, ethyl 4-dimethylaminobenzoate, isoamyl 4-dimethylaminobenzoate, (2-dimethylamino) ethyl benzoate, and 4,4′-dimethylaminobenzophenone.

The polymerization initiator may be used alone or in combination of two or more kinds thereof. A content of the polymerization initiator is 0.5 part by mass to 40 parts by mass, and preferably 1 part by mass to 20 parts by mass, with respect to 100 parts by mass of all compounds having a radical polymerization property.

(Charge Transport Material)

The present protective layer may contain a charge transport material from the viewpoint of imparting charge transporting ability.

The charge transport material contained in the present protective layer can use the same one as a hole transport material and an electron transport material used in the photosensitive layer.

From the viewpoint of improving the Martens hardness of the present photoreceptor surface, a structure obtained by polymerizing a charge transport material having a chain polymerizable functional group, may be included.

The chain polymerizable functional group of the charge transport material having a chain polymerizable functional group includes an acryloyl group, a methacryloyl group, a vinyl group, and an epoxy group. Among them, an acryloyl group or a methacryloyl group is preferred from the viewpoint of curability.

Examples of a structure of a charge transport material portion of the charge transport material having a chain polymerizable functional group include electron-donating materials such as heterocyclic compounds such as a carbazole derivative, an indole derivative, an imidazole derivative, and an oxazole derivative, an aniline derivative, a hydrazone derivative, an arylamine derivative, a stilbene derivative, a butadiene derivative, and an enamine derivative, and compounds each made of two or more of these compounds bonded together or polymers each having, in a main chain or a side chain thereof, a group constituted of any one of these compounds. Among them, a carbazole derivative, an arylamine derivative, a stilbene derivative, a butadiene derivative, an enamine derivative, or a compound made of a plurality of these compounds bonded together is preferred from the viewpoint of the electrical characteristics.

A content of the charge transport material in the present protective layer is not particularly limited. From the viewpoint of the electrical characteristics, the content is preferably 10 parts by mass or more, more preferably 30 parts by mass or more, and particularly preferably 50 parts by mass or more, with respect to 100 parts by mass of the binder resin in the present protective layer. From the viewpoint of maintaining good surface resistance, the content is preferably 300 parts by mass or less, more preferably 200 parts by mass or less, and particularly preferably 150 parts by mass or less.

Examples of the method for imparting the charge transporting ability to the present protective layer include a method for adding inorganic particles to be described later to the present protective layer in addition to the method for adding a charge transport material to the present protective layer. Among them, the method for adding a charge transport material to the present protective layer is preferred because the effects of the present invention can be more effectively obtained in the present protective layer.

(Inorganic Particles)

The present protective layer may contain inorganic particles from the viewpoint of improving the strong exposure characteristics and mechanical strength and from the viewpoint of imparting the charge transporting ability.

Examples of the inorganic particles include: metal powders such as copper, tin, and aluminum; metal oxides such as silica, tin oxide, zinc oxide, titanium oxide, alumina, indium oxide, and antimony-doped tin oxide; metal fluorides; potassium titanate; and boron nitride.

Among them, it is preferred to contain metal oxide particles as the inorganic particles.

As such metal oxide particles, any metal oxide particles that can be generally used in an electrophotographic photoreceptor can be used.

Specific examples of the metal oxide particles include metal oxide particles containing one metal element such as titanium oxide, tin oxide, aluminum oxide, silicon oxide, zirconium oxide, zinc oxide, and iron oxide, and metal oxide particles containing a plurality of metal elements such as calcium titanate, strontium titanate, and barium titanate. As for the metal oxide particles, only one kind of particles may be used, or a plurality of kinds of particles may be mixed and used.

Among them, metal oxide particles having a band gap smaller than the energy difference between the HOMO level and the LUMO level of the HTM in the photosensitive layer are preferred from the viewpoint of the strong exposure characteristics. Here, when a plurality of kinds of HTMs are used in the photosensitive layer, the HTM having a large number of parts by mass is used as a reference. When the band gap of the metal oxide particles is smaller than the energy difference, a wavelength absorbed by the hole transport material (HTM) can be cut according to an addition amount, and thus the strong exposure characteristics are improved. From such a viewpoint, metal oxide particles such as titanium oxide, zinc oxide, tin oxide, calcium titanate, strontium titanate, and barium titanate are preferred. Among them, titanium oxide particles are particularly preferred.

As a crystal form of the titanium oxide particles, any one of rutile, anatase, brookite, and amorphous can be used. From the viewpoint of the band gap and photocatalytic activity, the rutile-type is preferred. In addition, from the titanium oxide particles of different crystal states, titanium oxide particles of a plurality of crystal states may be contained.

The surface of the metal oxide particles may be subjected to various surface treatments. For example, the metal oxide particles may be treated with an inorganic compound such as tin oxide, aluminum oxide, antimony oxide, zirconium oxide, and silicon oxide, or with an organic compound such as stearic acid, a polyol, and an organosilicon compound. In particular, when titanium oxide particles are used, they are preferably surface-treated with an organosilicon compound.

Examples of the organosilicon compound include: silicone oils such as dimethylpolysiloxane and methylhydrogenpolysiloxane; organosilanes such as methyldimethoxysilane and diphenyldimethoxysilane; silazanes such as hexamethyldisilazane; and silane coupling agents such as 3-methacryloyloxypropyltrimethoxysilane, 3-acryloyloxypropyltrimethoxysilane, and vinyltrimethoxysilane. In particular, 3-methacryloyloxypropyltrimethoxysilane, 3-acryloyloxypropyltrimethoxysilane, or vinyltrimethoxysilane having a chain polymerizable functional group is preferred from the viewpoint of improving the mechanical strength of the outermost layer.

The outermost surface of the surface-treated particles may be treated with a treatment agent such as aluminum oxide, silicon oxide, or zirconium oxide before being treated with such a treatment agent.

As for the metal oxide particles, only one kind of particles may be used, or a plurality of kinds of particles may be mixed and used.

The metal oxide particles having an average primary particle diameter of 500 nm or less are generally preferably used, the metal oxide particles having an average primary particle diameter of 1 nm to 100 nm are more preferably used, and the metal oxide particles having an average primary particle diameter of 5 nm to 50 nm are even more preferably used.

The average primary particle diameter can be obtained based on an arithmetic average value of particle diameters directly observed with a transmission electron microscope (hereinafter also referred to as TEM).

A content of the inorganic particles in the present protective layer is preferably 0 part by mass or more and 20 parts by mass or less with respect to 100 parts by mass of the present protective layer.

When the content of the inorganic particles is large, the damage to the present photosensitive layer when receiving light is originally small. Therefore, from the viewpoint that the effects of the present invention can be further obtained, the content of the inorganic particles is preferably as small as possible.

From such a viewpoint, the content of the inorganic particles in the present protective layer is preferably 0 part by mass or more and 20 parts by mass or less, more preferably 15 parts by mass or less, and even more preferably 10 parts by mass or less, with respect to 100 parts by mass of the present protective layer.

(Other Materials)

The present protective layer may contain other materials, if necessary. Examples of the other materials include a stabilizer (such as a heat stabilizer, an ultraviolet absorber, a light stabilizer, and an antioxidant), a dispersant, an antistatic agent, a colorant, and a lubricant. These may be used alone or in any combination of two or more kinds thereof in any ratio as appropriate.

(Curing Method)

As a curing method, any method such as thermal curing, photocuring, electron beam curing, and radiation curing can be used. Photocuring which is excellent in safety and energy saving is preferred. Among photocuring, preferred is curing by irradiation with ultraviolet light and/or visible light, particularly curing by metal halide light and LED light, and more preferred is curing by LED light, in which the reaction can be controlled and heat generation can be prevented. From the viewpoint of a curing rate, a wavelength of the LED light is preferably 400 nm or less, and more preferably 385 nm or less, from the viewpoint of cost, is preferably 360 nm or less.

(Method for Forming Present Protective Layer)

The present protective layer can be formed by, for example, applying a coating liquid obtained by dissolving a curable composition containing a curable compound, a polymerization initiator, and, if necessary, metal oxide particles in a solvent, if necessary, or a coating liquid obtained by dispersing the curable composition metal oxide particles in a dispersion medium, and then curing the coating liquid.

At this time, as an organic solvent used for forming the present protective layer, a known organic solvent may be appropriately selected and used. Among them, it is preferred to contain alcohols having low solubility in polycarbonates and polyarylates that are suitably used in the photosensitive layer.

Examples of a coating method for forming the present protective layer include spray coating, ring coating, and dip coating. The present invention is not limited to these methods.

It is preferred that after a coating film is formed by the above coating method, the coating film is dried.

Curing of the curable composition can be performed by irradiating the curable composition with external energy such as heat, light (for example, ultraviolet light and/or visible light), or radiation.

Heat energy can be applied by heating from a coating surface side or a support side using, for example, gas such as air and nitrogen, steam, various heat media, infrared rays, or electromagnetic waves. A heating temperature is preferably 100° C. or higher and 170° C. or lower.

As light energy, an ultraviolet light (UV) emitting light source such as a high-pressure mercury lamp, a metal halide lamp, an electrodeless lamp bulb, or a light emitting diode having an emission wavelength mainly for UV can be used. A visible light source can be also selected in accordance with an absorption wavelength of the curable compound or the photopolymerization initiator.

From the viewpoint of the curability, the light intensity (light illuminance) is preferably 100 mW/cm² or more, more preferably 300 mW/cm² or more, even more preferably 600 mW/cm² or more, still more preferably 800 mW/cm² or more, even still more preferably 1000 mW/cm² or more, and particularly preferably 1200 mW/cm² or more. From the viewpoint of the electrical characteristics, the light intensity is preferably 5000 mW/cm² or less, more preferably 3000 mW/cm² or less, even more preferably 2000 mW/cm² or less, and particularly preferably 1500 mW/cm² or less.

The light intensity (light illuminance) can be measured using an accumulated UV meter. For example, an accumulated UV meter UIT-250 (photodetector UVD-C365) manufactured by Ushio, Inc. can be used.

From the viewpoint of the curability, a light emitting amount (accumulated light amount) is preferably 10 J/cm² or more, more preferably 30 J/cm² or more, even more preferably 50 J/cm² or more, still more preferably 100 J/cm² or more, even still more preferably 120 J/cm² or more, and particularly preferably 150 J/cm² or more. From the viewpoint of the electrical characteristics, the light emitting amount is preferably 500 J/cm² or less, more preferably 300 J/cm² or less, and particularly preferably 200 J/cm² or less.

Examples of radiation energy include those using an electron beam (EB).

Among the energy, light energy is preferred from the viewpoint of ease of reaction rate control, simplicity of apparatus, and length of pot life.

After the protective layer is cured, a heating step may be added from the viewpoint of alleviating residual stress, alleviating residual radicals, and improving the electrical characteristics. A heating temperature is preferably 60° C. or higher, and more preferably 100° C. or higher, and is preferably 200° C. or lower, and more preferably 150° C. or lower.

<Conductive Support>

The conductive support is not particularly limited as long as it supports a layer formed thereon and exhibits conductivity.

As the conductive support, for example, a metal material such as aluminum, an aluminum alloy, stainless steel, copper, or nickel, a resin material provided with conductivity by allowing a conductive powder of a metal, carbon, tin oxide, or the like to coexist, a resin obtained by depositing or applying a conductive material such as aluminum, nickel, or an indium tin oxide alloy (ITO) on a surface thereof, glass, and paper can be mainly used.

For example, the conductive support can be in a form of a drum, sheet, belt, or the like.

When a metal material such as an aluminum alloy is used as the conductive support, an anodized film may be applied to the metal material before use.

The surface of the conductive support may be smooth, or may be roughened by using a special cutting method or by performing a grinding treatment. The surface thereof may be roughened by mixing particles having an appropriate particle diameter with the material constituting the support.

An undercoat layer to be described later may be provided between the conductive support and the photosensitive layer in order to improve adhesion, blocking properties, and the like.

<Undercoat Layer>

The present photoreceptor may include the undercoat layer between the photosensitive layer and the conductive support.

As the undercoat layer, for example, a resin or a resin with an organic pigment or metal oxide particles dispersed therein can be used.

Examples of an organic pigment to be used in the undercoat layer include a phthalocyanine pigment, an azo pigment, and a perylene pigment. Among them, a phthalocyanine pigment and an azo pigment, specifically, a phthalocyanine pigment and an azo pigment in the case of being used as the above-described charge generation material can be exemplified.

Examples of metal oxide particles to be used in the undercoat layer include metal oxide particles containing one metal element such as titanium oxide, aluminum oxide, silicon oxide, and zinc oxide, and metal oxide particles containing a plurality of metal elements such as strontium titanate. As for the undercoat layer, only one kind of particles may be used, or a plurality of kinds of particles may be mixed and used in any ratio and in any combination.

Among the above metal oxide particles, titanium oxide or aluminum oxide is preferred, and titanium oxide is particularly preferred. The surface of the titanium oxide particles may be treated with, for example, an inorganic compound or an organic compound. As a crystal form of the titanium oxide particles, any one of rutile, anatase, brookite and amorphous can be used. In addition, titanium oxide particles of a plurality of crystal states may be contained.

A particle diameter of the metal oxide particles used in the undercoat layer is not particularly limited. In terms of properties of the undercoat layer and stability of the solution for forming the undercoat layer, an average primary particle diameter of the metal oxide particles is preferably 10 nm or more, and is preferably 100 nm or less, and more preferably 50 nm or less.

Here, the undercoat layer is preferably formed by dispersing particles in a binder resin. Examples of the binder resin to be used in the undercoat layer include: a polyvinyl butyral resin, a polyvinyl formal resin, and a polyvinyl acetal-based resin; insulating resins such as a polyarylate resin, a polycarbonate resin, a polyester resin, a polyamide resin, a polyurethane resin, a polyvinyl alcohol resin, and a silicon-alkyd resin; and organic photoconductive polymers such as poly-N-vinylcarbazole. The present invention is not limited to these polymers. The binder resin may be used alone, may be used in combination of two or more kinds thereof, or may be used in a form of being cured together with a curing agent.

Among them, a polyvinyl butyral resin, a polyvinyl formal resin, a polyvinyl acetal-based resin, an alcohol-soluble copolyamide, a modified polyamide, and the like are preferred because of exhibiting good dispersibility and coatability. Among them, an alcohol-soluble copolyamide is particularly preferred.

A mixing ratio of the particles to the binder resin can be freely selected. Use in a range of 10 mass % to 500 mass % is preferred in terms of stability and coatability of the dispersion liquid.

A film thickness of the undercoat layer can be freely selected. The film thickness is preferably 0.1 μm or more and 20 μm or less from the viewpoint of the characteristics of the electrophotographic photoreceptor and the coatability of the dispersion liquid. In addition, the undercoat layer may contain a known antioxidant or the like.

<<Present Image Forming Device>>

An image forming device (“the present image forming device”) includes the present photoreceptor. That is, the present image forming device according to one example of the embodiment of the present invention is an image forming device including the present photoreceptor.

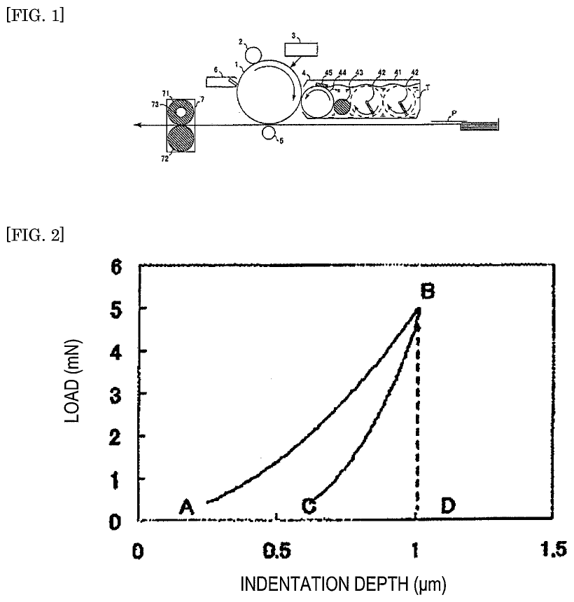

As shown in FIG. 1, the present image forming device includes the present photoreceptor 1, a charging device 2, an exposure device 3, and a developing device 4, and further includes, if necessary, a transfer device 5, a cleaning device 6, and a fixing device 7.

The present photoreceptor 1 is not particularly limited as long as it is the electrophotographic photoreceptor according to the present invention. FIG. 1 shows, as an example, a drum-shaped photoreceptor in which the above-described photosensitive layer is formed on the surface of a cylindrical conductive support.

The charging device 2, the exposure device 3, the developing device 4, the transfer device 5, and the cleaning device 6 are arranged along an outer peripheral surface of the present photoreceptor 1.

The charging device 2 charges the present photoreceptor 1, and uniformly charges the surface of the present photoreceptor 1 to have a predetermined potential. Examples of a general charging device include a non-contact corona charging device such as a corotron and a scorotron, and a contact type charging device (direct type charging device). Examples of the contact type charging device include a charging roller and a charging brush. FIG. 1 shows a roller type charging device (a charging roller) as an example of the charging device 2.

The voltage applied during charging may be only a direct current voltage, or an alternating current voltage superimposed on a direct current voltage.

The kind of the exposure device 3 is not particularly limited as long as it can expose the present photoreceptor 1 to form an electrostatic latent image on the photosensitive surface of the present photoreceptor 1. Specific examples thereof include a halogen lamp, a fluorescent lamp, a laser, and an LED.

In addition, the exposure may be performed by a photoreceptor internal exposure method. Any light may be used for exposure. For example, exposure may be performed with monochromatic light having a wavelength of 780 nm.

Any kind of toner T may be used, and a powder toner, a polymerized toner, or the like can be used.

The kind of the transfer device 5 is not particularly limited, and a device using any method such as an electrostatic transfer method, a pressure transfer method, or an adhesive transfer method can be used. Here, it is assumed that the transfer device 5 includes a transfer charger, a transfer roller, a transfer belt, and the like which are disposed to face the present photoreceptor 1. The transfer device 5 applies a predetermined voltage (a transfer voltage) having a polarity opposite to a charge potential of the toner T, and transfers a toner image formed on the present photoreceptor 1 to a recording sheet (paper, a medium) P.

The cleaning device 6 is not particularly limited, and any cleaning device such as a brush cleaner, a magnetic roller cleaner, and a blade cleaner can be used. The cleaning device 6 scrapes off the residual toner adhering to the photoreceptor 1 with a cleaning member and collects the residual toner. When there is little or almost no toner remaining on the photoreceptor surface, the cleaning device 6 may be omitted.

In the present image forming device configured as described above, image recording is performed as follows. First, the surface (the photosensitive surface) of the photoreceptor 1 is charged to have a predetermined potential (for example, 600 V) by the charging device 2. At this time, the photosensitive surface of the photoreceptor 1 may be charged with a direct current voltage, or may be charged by superimposing an alternating current voltage on a direct current voltage.

Subsequently, the charged photosensitive surface of the photoreceptor 1 is exposed by the exposure device 3 in accordance with an image to be recorded to form an electrostatic latent image on the photosensitive surface. Then, the electrostatic latent image formed on the photosensitive surface of the photoreceptor 1 is developed by the developing device 4.

The developing device 4 thins the toner T supplied by a supply roller 43 by a regulating member (a developing blade) 45, frictionally charges the toner T to have a predetermined polarity (here, a positive polarity same as the charging potential of the photoreceptor 1), conveys the toner T while carrying the toner T on the developing roller 44, and brings the toner T into contact with the surface of the photoreceptor 1.

When the charged toner T carried on the developing roller 44 is brought into contact with the surface of the photoreceptor 1, a toner image corresponding to the electrostatic latent image is formed on the photosensitive surface of the photoreceptor 1. The toner image is transferred onto the recording paper P by the transfer device 5. Thereafter, the toner remaining on the photosensitive surface of the photoreceptor 1 without being transferred is removed by the cleaning device 6.

After the toner image is transferred onto the recording paper P, the toner image is thermally fixed onto the recording paper P by being passed through the fixing device 7 to obtain a final image.

In addition to the configuration described above, the image forming device may have, for example, a configuration capable of performing a charge elimination step.

The present image forming device may be further modified and configured. For example, the image forming device may be configured to perform a step such as a pre-exposure step and an auxiliary charging step, may be configured to perform offset printing, or may be configured to be of a full-color tandem type using a plurality of types of toners.

<<Present Electrophotographic Cartridge>>

An electrophotographic cartridge according to one example of an embodiment of the present invention (referred to as “the present electrophotographic cartridge”) is an electrophotographic cartridge including the present photoreceptor.

The present photoreceptor 1 can be combined with one or more of the charging device 2, the exposure device 3, the developing device 4, the transfer device 5, the cleaning device 6, and the fixing device 7 to form an integrated cartridge.

The present electrophotographic cartridge can be configured to be detachable from an electrophotographic apparatus main body such as a copier or a laser beam printer. In this case, for example, when the present photoreceptor 1 or other members are deteriorated, the electrophotographic photoreceptor cartridge is detached from an image forming device main body, and another new electrophotographic photoreceptor cartridge is attached to the image forming device main body, thereby facilitating maintenance and management of the image forming device.

<<Description of Phrases>>

In the present invention, unless otherwise specified, “X to Y” (X and Y are any number) includes a meaning of “X or more and Y or less”, and also includes a meaning of “preferably larger than X” or “preferably smaller than Y”.

In addition, “X or more” (X is any number) or “Y or less” (Y is any number) also includes an intention of “preferably larger than X” or “preferably smaller than Y”.

### EXAMPLES

The present invention will be further illustrated by the following Examples, which are not intended to limit the present invention in any way.

First, Examples and Comparative Examples of the first embodiment of the present invention will be described.

[Measurement of Absorbance and Calculation of Absorbance Area Ratio]

The absorbance of each of protective layers of photoreceptors obtained in Examples and Comparative Examples was measured at a wavelength of 800 cm-1 to 4000 cm⁻¹ using a Fourier transform infrared spectrophotometer (Nicolet iS5 manufactured by Thermo Fisher Scientific Inc.) with an ATR attachment (crystal: germanium). From the chart, an area ratio A/B, that is, an absorbance ratio A/B, was obtained by defining an absorbance area at a wavelength of 1647 cm⁻¹ to 1627 cm⁻¹ as A and an absorbance area of a peak at a wavelength of 1800 cm⁻¹ to 1647 cm⁻¹ as B. The area described above is an area above a baseline.

[Measurement and Calculation of Curing Degree]

For each of the photosensitive layers before curing in Examples and Comparative Examples, the area ratio A/B before curing was determined in exactly the same manner as in the determination of the area ratio A/B after curing. The curing degree was obtained according to the following equation.

Curing degree=[1−[(A/B after curing)/(A/B before curing)]]×100

[Measurement of Martens Hardness and Elastic Deformation Ratio]

Each of photoreceptors A to I obtained in Examples and Comparative Examples was subjected to measurement under the following measurement conditions from the front surface side of the photoreceptor under an environment of a temperature of 25° C. and a relative humidity of 50% by using a microhardness tester (FISCHERSCOPE HM 2000, manufactured by Fischer). Table 1 shows the Martens hardness and the elastic deformation ratio of each sample.

(Measurement Conditions of Martens Hardness and Elastic Deformation Ratio)

Indenter: Vickers quadrangular pyramid diamond indenter having facing angle of 1360

Maximum indentation load: 0.2 mN

Loading time: 10 seconds

Loading removing time: 10 seconds

The Martens hardness is determined according to the following equation.

Martens hardness (N/mm²)=maximum indentation load/indentation area at maximum indentation load

The elastic deformation ratio is a value defined by the following equation, and is a proportion of a work performed by a film elastically during load removal to a total work required for indentation.

Elastic deformation ratio (%)=(We/Wt)×100

In the above equation, the total work Wt (nJ) is an area surrounded by A-B-D-A in FIG. 2, and the elastic deformation work We (nJ) is an area surrounded by C-B-D-C. The larger the elastic deformation ratio is, the more difficult it is for deformation to remain under a load, and an elastic deformation ratio of 100 means that no deformation remains.

[Coating Liquid P1 for Forming Undercoat Layer]

A coating liquid P1 for forming an undercoat layer was obtained by containing rutile-type white titanium oxide surface-treated with methyldimethoxysilane and a copolyamide in which a composition molar ratio of ε-caprolactam/bis(4-amino-3-methylcyclohexyl)methane/hexamethylenediamine/decamethylenedicarboxylic acid/octadecamethylenedicarboxylic acid was 60/15/5/15/5 <mass ratio of titanium oxide to copolyamide: 3/1> in a solvent mixture (mass ratio of methanol/1-propanol/toluene: 7/1/2) at a solid content concentration of 18%.

[Coating Liquid Q1 for Forming Charge Generation Layer]

10 parts of oxytitanium phthalocyanine, having a characteristic peak at a Bragg angle (2θ±0.2°) of 27.3° in a powder X-ray spectrum pattern using CuKα rays, as a charge generation material, 5 parts of a polyvinyl acetal resin (trade name: DK31, manufactured by Denki Kagaku Kogyo Co., Ltd.) as a binder resin, and 500 parts of 1,2-dimethoxyethane were mixed, and the mixture was pulverized by a sand grind mill and subjected to a dispersion treatment to obtain a coating liquid Q1 for forming a charge generation layer.

[Coating Liquid R1 for Forming Charge Transport Layer]

100 parts by mass of a polyarylate resin represented by the following structural formula (A) (viscosity average molecular weight: 43,000) as a binder resin, 75 parts by mass of a hole transport material (HTM) (energy difference between a HOMO level and a LUMO level: 3.05 eV, molecular weight: 745.0) represented by the following structural formula (B), 1 part by mass of a radical acceptor compound represented by the following structural formula (C) (electron transport material (ETM), molecular weight: 424.6) (that is, 1.3 parts by mass with respect to 100 parts by mass of HTM), 4 parts by mass of a hindered phenol-based antioxidant (trade name: Irg1076, manufactured by BASF), and 0.05 part by mass of a silicone oil (trade name: KF-96, manufactured by Shin-Etsu Chemical Co., Ltd.) were dissolved in a solvent mixture of tetrahydrofuran:toluene=8/2 (mass ratio), and mixed with stirring to obtain a coating liquid R1 for forming a charge transport layer having a solid content concentration of 18.0 mass %.

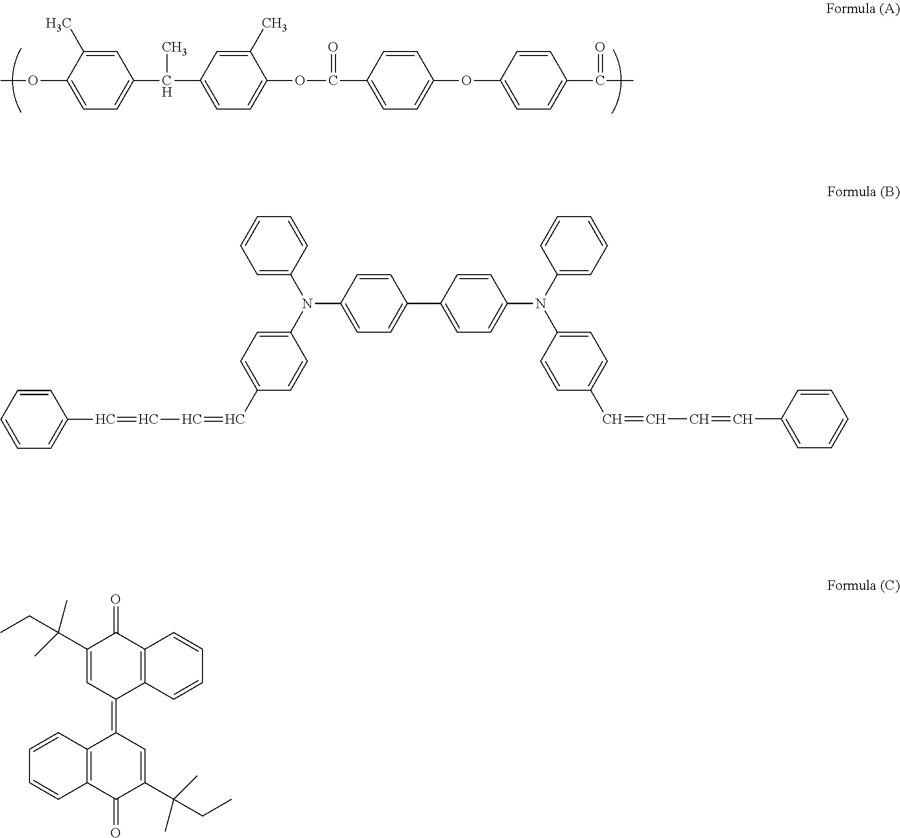

[Coating Liquid R2 for Forming Charge Transport Layer]

A coating liquid R2 for forming a charge transport layer was obtained in the same manner as in the coating liquid R1 for forming a charge transport layer except that the radical acceptor compound (electron transport material (ETM)) was changed to a compound represented by the following structural formula (D) (molecular weight: 324.5).

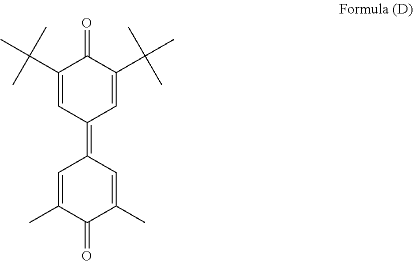 [SMILES: CC1=CC(=C2C=C(C(C)(C)C)C(=O)C(C(C)(C)C)=C2)C=C(C)C1=O]

[Coating Liquid R3 for Forming Charge Transport Layer]

A coating liquid R3 for forming a charge transport layer was obtained in the same manner as in the coating liquid R1 for forming a charge transport layer except that the radical acceptor compound (electron transport material (ETM)) was changed to a compound represented by the following structural formula (E) (molecular weight: 363.5).

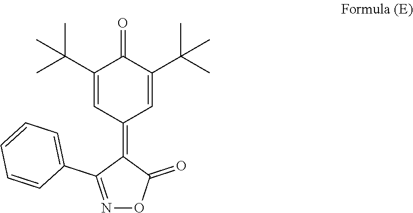 [SMILES: CC(C)(C)C1=CC(=C2C(=O)ON=C2c2ccccc2)C=C(C(C)(C)C)C1=O]

[Coating Liquid R4 for Forming Charge Transport Layer]

A coating liquid R4 for forming a charge transport layer was obtained in the same manner as in the coating liquid R1 for forming a charge transport layer except that a content of the radical acceptor compound (electron transport material (ETM)) was changed to 0.5 part by mass (that is, 0.7 part by mass with respect to 100 parts by mass of the HTM).

[Coating Liquid R5 for Forming Charge Transport Layer]

100 parts by mass of a polyarylate resin represented by the structural formula (A) (viscosity average molecular weight: 43,000) as a binder resin, 75 parts by mass of a hole transport material (HTM) represented by the structural formula (B), 4 parts by mass of a hindered phenol-based antioxidant (trade name: Irg1076, manufactured by BASF), and 0.05 part by mass of a silicone oil (trade name: KF-96, manufactured by Shin-Etsu Chemical Co., Ltd.) were dissolved in a solvent mixture of tetrahydrofuran:toluene=8/2 (mass ratio), and mixed with stirring to obtain a coating liquid R5 for forming a charge transport layer having a solid content concentration of 18.0 mass %.

[Coating Liquid R6 for Forming Charge Transport Layer]

100 parts by mass of a polyarylate resin represented by the structural formula (A) (viscosity average molecular weight: 43,000) as a binder resin, 75 parts by mass of a hole transport material (HTM) represented by the structural formula (B), 2 parts by mass of a light shielding agent represented by the following structural formula (F), 4 parts by mass of a hindered phenol-based antioxidant (trade name: Irg1076, manufactured by BASF), and 0.05 part by mass of a silicone oil (trade name: KF-96, manufactured by Shin-Etsu Chemical Co., Ltd.) were dissolved in a solvent mixture of tetrahydrofuran:toluene=8/2 (mass ratio), and mixed with stirring to obtain a coating liquid R6 for forming a charge transport layer having a solid content concentration of 18.0 mass %.

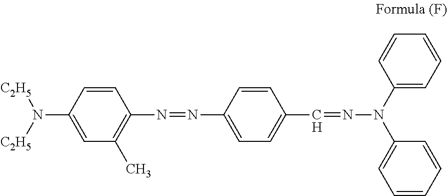 [SMILES: CCN(CC)c1ccc(N=Nc2ccc(C=NN(c3ccccc3)c3ccccc3)cc2)c(C)c1]

[Coating Liquid S1 for Forming Protective Layer]

A polyester acrylate (product name: M-9050, manufactured by TOAGOSEI CO., LTD.) dissolved in a 2-propanol solvent in advance, a hole transport material (HTM) represented by a formula (G) dissolved in a tetrahydrofuran solvent in advance, benzophenone and Omnirad TPO H (2,4,6-trimethylbenzoyl-diphenylphosphine oxide) as a polymerization initiator, and a fluorine-based leveling agent (product name: F-563, manufactured by DIC CORPORATION) were mixed at a mass ratio of M-9050/hole transport material (HTM) represented by the formula (G)/benzophenone/Omnirad TPO H/F-563=100/100/1/2/0.1 in a solvent having a solvent composition of 2-propanol/tetrahydrofuran=8/2 to obtain a coating liquid S1 for forming a protective layer having a solid content concentration of 9.7 mass %.

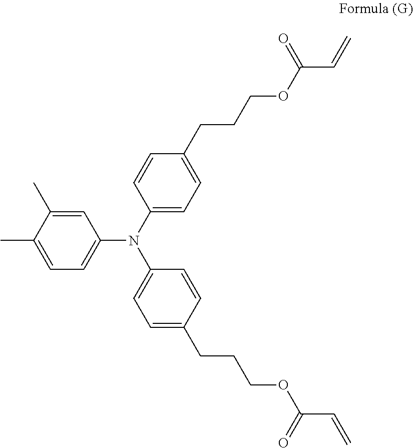 [SMILES: C=CC(=O)OCCCc1ccc(N(c2ccc(CCCOC(=O)C=C)cc2)c2ccc(C)c(C)c2)cc1]

### Example 1

An aluminum cylinder having a diameter of 30 mm and a length of 248 mm, the surface of which had been subjected to cutting, was dip-coated with the coating liquid P1 for forming an undercoat layer, and then an undercoat layer was provided such that a dry film thickness thereof was 1.5 μm. The undercoat layer was dip-coated with the coating liquid Q1 for forming a charge generation layer to form a charge generation layer such that a dry film thickness thereof was 0.3 μm. The charge generation layer was dip-coated with the coating liquid R1 for forming a charge transport layer to form a charge transport layer such that a dry film thickness thereof was 20.0 μm. The charge transport layer was ring-coated with the coating liquid S1 for forming a protective layer, dried at room temperature for 20 minutes, and then irradiated with LED light having 385 nm at an intensity of 1285 mW/cm² for 2 minutes while rotating the photoreceptor at 60 rpm in a nitrogen atmosphere (oxygen concentration: 1% or less) to form a protective layer having a cured film thickness of 1.0 μm. After formation of the protective layer, heating was performed at 125° C. for 10 minutes. Thereafter, the resultant was aged at 55° C. overnight to prepare a photoreceptor A.

The intensity of the LED light was measured using an accumulated UV meter UIT-250 (a light receiver UVD-C365) manufactured by Ushio Inc.

### Example 2

A photoreceptor B was prepared in the same manner as in the preparation of the photoreceptor A except that the coating liquid R1 for forming a charge transport layer was changed to the coating liquid R2 for forming a charge transport layer.

### Example 3

A photoreceptor C was prepared in the same manner as in the preparation of the photoreceptor A except that the coating liquid R1 for forming a charge transport layer was changed to the coating liquid R3 for forming a charge transport layer.

### Example 4

A photoreceptor D was prepared in the same manner as in the preparation of the photoreceptor A except that the coating liquid R1 for forming a charge transport layer was changed to the coating liquid R4 for forming a charge transport layer.

### Comparative Example 1

A photoreceptor E was prepared in the same manner as in the preparation of the photoreceptor A except that the coating liquid R1 for forming a charge transport layer was changed to the coating liquid R5 for forming a charge transport layer.

### Comparative Example 2

A photoreceptor F was prepared in the same manner as in the preparation of the photoreceptor A except that the coating liquid R1 for forming a charge transport layer was changed to the coating liquid R6 for forming a charge transport layer.

### Comparative Example 3

A photoreceptor G was prepared in the same manner as in the preparation of the photoreceptor A except that the intensity of the LED light having 385 nm was changed to 685 mW/cm² and the irradiation time was changed to 1 minute.

### Comparative Example 4

A photoreceptor H was prepared in the same manner as in the preparation of the photoreceptor E except that the intensity of the LED light having 385 nm was changed to 685 mW/cm² and the irradiation time was changed to 1 minute.

### Comparative Example 5

A photoreceptor I was prepared in the same manner as in the preparation of the photoreceptor F except that the intensity of the LED light having 385 nm was changed to 685 mW/cm² and the irradiation time was changed to 1 minute.

[Initial Electrical Characteristics]

Using an electrophotographic characteristic evaluation apparatus (described in Basics and Applications of Sequel Electrophotography Technique, edited by The Society of Electrophotography of Japan, CORONA PUBLISHING CO., LTD, p. 404-405) manufactured according to the standards of the Society of Electrophotography of Japan, the photoreceptors A to I were rotated at a constant number of rotations, and subjected to an electrical characteristic evaluation test with cycles of charging, exposure, potential measurement, and charge elimination. At this time, the initial surface potential was −700 V, monochromatic light having 780 nm was used for exposure, monochromatic light having 660 nm was used for charge elimination, and the surface potential (VL) was measured at the time of irradiation with exposure light at 1.0 μJ/cm². In the VL measurement, the time required from exposure to potential measurement was 60 ms. The measurement environment was a temperature of 25° C. and a relative humidity of 50% (N/N environment).

The smaller the VL, the better the initial electrical characteristics. In the present invention, a case where the VL was 75 (−V) or less was evaluated as “acceptable”.

[Strong Exposure Characteristics]

The photoreceptors A to I were mounted on an electrophotographic characteristic evaluation apparatus (described in Basics and Applications of Sequel Electrophotography Technique, edited by The Society of Electrophotography of Japan, CORONA PUBLISHING CO., LTD, p. 404-405) manufactured according to the standards of the Society of Electrophotography of Japan, and the electrical characteristics with cycles of charging, exposure, potential measurement, and charge elimination were measured as follows.

First, under an environment of a temperature of 25° C. and a humidity of 50%, a grid voltage was adjusted to charge the photoreceptors so as to have an initial surface potential (V0) of −700 V. Next, the surface potential (VL) was measured after 100-millisecond exposure to exposure light at an intensity of 0.44 μJ/cm². As the exposure light, monochromatic light having 780 nm obtained from a halogen lamp with an interference filter was used.

Subsequently, the photoreceptors were irradiated with light from a white fluorescent lamp (NEORMISUPER FL20SS W/18, manufactured by Mitsubishi Electric Osram Ltd.) for 10 minutes while adjusting the light intensity on the photoreceptor surface to 2000 lux. Thereafter, immediately after the irradiation, 10 minutes after the irradiation, and 60 minutes after the irradiation, the same measurement was performed at an initial grid voltage, and V0 and VL were measured.

The measurement environment was a temperature of 25° C. and a relative humidity of 50% (N/N environment).

ΔV0 is a value obtained by subtracting V0 before the white fluorescent lamp irradiation from V0 after the white fluorescent lamp irradiation. ΔVL is a value obtained by subtracting VL before the white fluorescent lamp irradiation from VL after the white fluorescent lamp irradiation. The smaller the absolute values of ΔV0 and ΔVL, the smaller the change in each potential even when irradiated with white light having a high intensity, and the better the strong exposure characteristics. In the present invention, a case where absolute values of ΔV0 and ΔVL were as follows was evaluated as “acceptable”.

ΔV0 (immediately after irradiation): 11 or less

ΔV0 (10 minutes after irradiation): 8 or less

ΔV0 (60 minutes after irradiation): 7 or less

ΔVL (immediately after irradiation): 14 or less

ΔVL (10 minutes after irradiation): 10 or less

ΔVL (60 minutes after irradiation): 5 or less

[Transfer Repeatability (Transfer Long)]

First, the initial VL (before repeated transfer) was measured by the following procedure. Using an electrophotographic characteristic evaluation apparatus (described in Basics and Applications of Sequel Electrophotography Technique, edited by The Society of Electrophotography of Japan, CORONA PUBLISHING CO., LTD, p. 404-405) manufactured according to the standards of the Society of Electrophotography of Japan, the photoreceptors A to I obtained in Examples and Comparative Examples were subjected to an electrical characteristic evaluation test at a rotation speed of 60 rpm with cycles of charging, exposure, potential measurement, and charge elimination. At this time, the initial surface potential was −700 V, monochromatic light having 780 nm was used for exposure, monochromatic light having 660 nm was used for charge elimination, and the surface potential (VL) was measured at the time of irradiation with exposure light at 0.44 μJ/cm². In the VL measurement, the time required from exposure to potential measurement was 100 ms.

Next, the VL after repeated transfer was evaluated by the following procedure. While charging (scorotron charger) conditions were fixed such that the initial surface potential of the photoreceptor was −700V, the photoreceptor was rotated 4000 times while a positive voltage of 6.5 kV was applied to another corotron charger. The corotron charger was installed between potential measurement and charge elimination. After the 4000-time rotation, the positive voltage was turned off and the surface potential VL was measured in the same manner as in the initial stage.

Both before and after repeated transfer, the measurement environment was a temperature of 25° C. and a relative humidity of 50% (N/N environment).

A difference between the VL before repeated transfer and the VL after repeated transfer was defined as ΔVL. The smaller the absolute value of ΔVL, the smaller the change in potential even when the transfer is repeated, and the better the transfer repeatability. In the present invention, a case where the absolute value of ΔVL was 130 or less was evaluated as “acceptable”.

TABLE 1

| | | | | Radical acceptor compound | | | | | | | | |
|---|---|---|---|---|---|---|---|---|---|---|---|---|
| | | | | | | Energy | Content | | | | | |
| | | | | | | difference | (part by | | | | | |
| | | | | | | (eV) | mass) | | | | | |
| | LED light | | | | | between | with | | | | | |
| | irradiation condition | | | | | HOMO | respect to | | | | | Elastic |
| | Wave- | Intensity | | | Electron | level and | 100 parts | | Area | | Martens | de- |
| | length | (mW/ | Time | Structural | affinity | LUMO | by mass | | ratio | Curing | hardness | formation |
| | (nm) | cm²) | (minute) | formula | (eV) | level | of HTM | Additive | A/B | degree | (N/mm²) | ratio (%) |
| Example 1 | 385 | 1285 5 | 2 | C | 3.83 | 2.39 | 1.3 | No | 0.0038 | 77.3 | 222 | 37.9 |
| Example 2 | 385 | 1285 | 2 | D | 3.97 | 2.50 | 1.3 | No | 0.0027 | 86.2 | 219 | 41.0 |
| Example 3 | 385 | 1285 | 2 | E | 4.19 | 2.90 | 1.3 | No | 0.0034 | 82.4 | 214 | 39.5 |
| Example 4 | 385 | 1285 | 2 | C | 3.83 | 2.39 | 0.7 | No | 0.0030 | 84.7 | 216 | 38.8 |
| Comparative | 385 | 1285 | 2 | No | — | — | — | No | 0.0035 | 78.8 | 220 | 37.1 |
| Example 1 | | | | | | | | | | | | |
| Comparative | 385 | 1285 | 2 | No | — | — | — | D | 0.0038 | 77.0 | 215 | 37.7 |
| Example 2 | | | | | | | | | | | | |
| Comparative | 385 | 685 | 1 | C | 3.83 | 2.39 | 1.3 | No | 0.0057 | 65.7 | 217 | 33.1 |
| Example 3 | | | | | | | | | | | | |
| Comparative | 385 | 685 | 1 | No | — | — | — | No | 0.0057 | 65.3 | 209 | 35.5 |
| Example 4 | | | | | | | | | | | | |
| Comparative | 385 | 685 | 1 | No | — | — | — | D | 0.0057 | 65.3 | 205 | 39.5 |
| Example 5 | | | | | | | | | | | | |

TABLE 2

| | | Strong exposure characteristics | | | | | | |
|---|---|---|---|---|---|---|---|---|
| | Initial | ΔV0 (V) | | | ΔVL (V) | | | |
| | electrical | Immediately | 10 minutes | 60 minutes | Immediately | 10 minutes | 60 minutes | Transfer |
| | characteristics | after | after | after | after | after | after | repeatability |
| | VL (−V) | irradiation | irradiation | irradiation | irradiation | irradiation | irradiation | ΔVL (V) |
| Example 1 | 45 | −1 | 0 | 2 | 8 | 4 | 4 | −73 |
| Example 2 | 54 | 6 | 1 | 0 | 10 | 7 | 4 | −127 |
| Example 3 | 72 | 9 | 7 | 4 | 14 | 10 | 5 | −122 |
| Example 4 | 41 | 11 | 8 | 7 | 7 | 3 | 1 | −77 |
| Comparative | 40 | 67 | 44 | 22 | 30 | 29 | 23 | −137 |
| Example 1 | | | | | | | | |
| Comparative | 80 | 8 | 7 | 4 | 7 | 1 | −2 | −45 |
| Example 2 | | | | | | | | |
| Comparative | 29 | −5 | −2 | −8 | −1 | 5 | −6 | −45 |
| Example 3 | | | | | | | | |
| Comparative | 31 | 24 | 16 | 8 | −13 | −27 | −32 | −45 |
| Example 4 | | | | | | | | |
| Comparative | 37 | 12 | 9 | 8 | 7 | 10 | 8 | −30 |
| Example 5 | | | | | | | | |

It is confirmed from Tables 1 and 2 that, when comparing Examples 1 to 4 with Comparative Examples 1 to 5, when the area ratio A/B is 0.0045 or less, where A is the absorbance area at a wavelength of 1647 cm⁻¹ to 1627 cm⁻¹ and B is the absorbance area of a peak at a wavelength of 1800 cm⁻¹ to 1647 cm⁻¹ in the infrared absorption spectrum measurement of the protective layer, and the photosensitive layer contains at least the hole transport material (HTM) and the radical acceptor compound, the protective layer has a high curing degree, the curing degree is also high, the Martens hardness and the elastic deformation ratio are also high, and the initial electrical characteristics, the strong exposure characteristics, and the transfer repeatability are all good.

When comparing Example 1 with Comparative Example 1, it is found that when the photosensitive layer contains the electron transport material (ETM) and the hole transport material (HTM), the initial electrical characteristics, the strong exposure characteristics, and the transfer repeatability are all good, and when the photosensitive layer does not contain the electron transport material (ETM), any of the characteristics is poor.

In addition, in Comparative Example 2, it is found that, in the case where the photosensitive layer contains a known light shielding agent (the compound of the formula (F) instead of the electron transport material (ETM) in Example 1, in particular, the initial electrical characteristics are deteriorated. It is presumed that this is because the compound of the formula (F) itself is partly photodecomposed by the curing light (the LED light), and the electrical characteristics are deteriorated due to the influence of the photodecomposition product.

Here, when the photosensitive layer contains not only the hole transport material (HTM) but also the radical acceptor compound (the electron transport material (ETM)), the radical acceptor compound (ETM) is more likely to be radicalized than the HTM. Therefore, it can be considered that even when an HTM radical is generated, the HTM radical immediately extracts a hydrogen atom from the radical acceptor compound (ETM) and is converted into the HTM, thereby exhibiting the effect as in Example 1.

Further, a sheet photoreceptor sample was prepared as follows, and the curing degree, the initial electrical characteristics, the strong exposure characteristics, and the transfer repeatability were evaluated.

Since it is difficult to accurately measure the Martens hardness and the elastic deformation ratio of the sheet photoreceptor sample, these characteristics were not measured.

[Coating Liquid R7 for Forming Charge Transport Layer]

A coating liquid R7 for forming a charge transport layer was obtained in the same manner as in the coating liquid R1 for forming a charge transport layer except that the radical acceptor compound (the electron transport material (ETM)) was changed to a compound represented by the following structural formula (H) (molecular weight: 356.9).

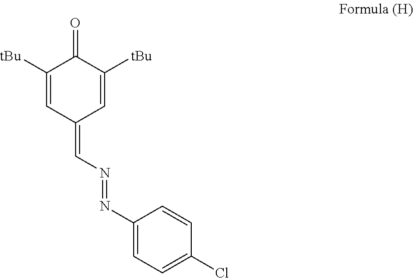 [SMILES: CC(C)(C)C1=CC(=C/N=N/c2ccc(Cl)cc2)C=C(C(C)(C)C)C1=O]

### Example 5

A polyethylene terephthalate sheet (thickness: 75 μm) whose surface was vapor-deposited with aluminum was coated with the coating liquid P1 for forming an undercoat layer with a wire bar such that the film thickness after drying was 1.2 μm, and dried to form an undercoat layer. The undercoat layer was coated with the coating liquid Q1 for forming a charge generation layer with a wire bar such that the film thickness after drying was 0.2 μm, and dried to form a charge generation layer. Next, the charge generation layer was coated with the coating liquid R7 for forming a charge transport layer with an applicator such that the film thickness after drying was 20 μm, and dried at 125° C. for 20 minutes to form a charge transport layer.

Finally, the charge transport layer was coated with the coating liquid S1 for forming a protective layer with a wire bar, and dried at room temperature for 20 minutes, then the sheet was wound around an aluminum cylinder (diameter: 30, length: 248 mm), the coating film (all layers formed on the vapor-deposited aluminum) was peeled off by about 1 cm² at the end portion thereof, and a conductive tape was attached to the cylinder from the vapor-deposited aluminum portion exposed after peeling, thereby establishing conduction between the sheet and the cylinder. Thereafter, a curing treatment same as that in Example 1 was performed to form a protective layer having a film thickness of 1.0 μm.

After forming the protective layer, heating and aging were performed in the same manner as in Example 1, and a sheet photoreceptor J was prepared.

### Comparative Example 6

A sheet photoreceptor K was prepared in the same manner as the photoreceptor sheet J except that the coating liquid R7 for forming a charge transport layer was changed to the coating liquid R5 for forming a charge transport layer.

For the sheet photoreceptors J and K, the curing degree, the initial electrical characteristics, the strong exposure characteristics, and the transfer repeatability were measured according to the procedure described above. Each sheet photoreceptor was used for each measurement after conducting with the aluminum vapor-deposited layer of the aluminum cylinder.

Measurement results are shown in Tables 3 and 4.

TABLE 3

| | | | | Radical acceptor compound | | | | | | |
|---|---|---|---|---|---|---|---|---|---|---|
| | | | | | | Energy | Content | | | |
| | | | | | | difference | (part by | | | |
| | | | | | | (eV) | mass) | | | |
| | | | | | | between | with | | | |
| | | | | | | HOMO | respect to | | | |
| | LED light irradiation condition | | | | Electron | level and | 100 parts | | Area | |
| | Wavelength | Intensity | Time | Structural | affinity | LUMO | by mass | | ratio | Curing |
| | (nm) | (mW/cm²) | (minute) | formula | (eV) | level | of HTM | Additive | A/B | degree |
| Example 5 | 385 | 1285 | 2 | H | 3.83 | 2.75 | 1.3 | No | 0.0045 | 76.7 |
| Comparative | 385 | 1285 | 2 | No | — | — | — | No | 0.0044 | 77.2 |
| Example 6 | | | | | | | | | | |

TABLE 4

| | | Strong exposure characteristics | | | | | | |
|---|---|---|---|---|---|---|---|---|
| | Initial | ΔV0 (V) | | | ΔVL (V) | | | |
| | electrical | Immediately | 10 minutes | 60 minutes | Immediately | 10 minutes | 60 minutes | Transfer |
| | characteristics | after | after | after | after | after | after | repeatability |
| | VL (−V) | irradiation | irradiation | irradiation | irradiation | irradiation | irradiation | ΔVL (V) |
| Example 5 | 73 | 9 | 4 | 4 | 4 | 1 | 0 | −62 |
| Comparative | 60 | 3 | 2 | −1 | 1 | −19 | −25 | −103 |
| Example 6 | | | | | | | | |

It is confirmed from Tables 3 and 4 that, when comparing Example 5 with Comparative Example 6, in the case of a sheet-type photoreceptor, as in the case of a drum-type photoreceptor, when the area ratio A/B is 0.0045 or less, where A is the absorbance area at a wavelength of 1647 cm⁻¹ to 1627 cm⁻¹ and B is the absorbance area of a peak at a wavelength of 1800 cm⁻¹ to 1647 cm⁻¹ in the infrared absorption spectrum measurement of the protective layer, and the photosensitive layer contains at least the hole transport material (HTM) and the radical acceptor compound, the protective layer has a high curing degree, the curing degree is also high, and the initial electrical characteristics, the strong exposure characteristics, and the transfer repeatability are all good.

From the results of the above Examples and Comparative Examples and the results of the tests conducted by the present inventor, it is found that when the photosensitive layer contains the radical acceptor compound and the hole transport material (HTM), the initial electrical characteristics, the strong exposure characteristics, and the transfer repeatability are excellent even when the curing degree of the protective layer is high. It is presumed that this is because the presence of the radical acceptor compound can prevent the decomposition of the HTM, thereby preventing damage to the photosensitive layer.

Further, when a radical acceptor compound whose energy difference between the HOMO level and the LUMO level is 1.8 eV or more and 3.0 eV or less is used as the radical acceptor compound, particularly, the strong exposure characteristics can be further enhanced due to excellent light-shielding ability.

Next, Experimental Examples according to the second embodiment of the present invention will be described.

### Experimental Example 2-1

A photoreceptor 2-A was prepared in the same manner as in Example 1 described above.

### Experimental Example 2-2

A photoreceptor 2-B was prepared in the same manner as in the preparation of the photoreceptor 2-A except that the coating liquid R1 for forming a charge transport layer was changed to the coating liquid R2 for forming a charge transport layer.

### Experimental Example 2-3

A photoreceptor 2-C was prepared in the same manner as in the preparation of the photoreceptor 2-A except that the coating liquid R1 for forming a charge transport layer was changed to the coating liquid R3 for forming a charge transport layer.

### Experimental Example 2-4

A photoreceptor 2-D was prepared in the same manner as in the preparation of the photoreceptor 2-A except that the coating liquid R1 for forming a charge transport layer was changed to the coating liquid R4 for forming a charge transport layer.

### Experimental Example 2-5

A photoreceptor 2-E was prepared in the same manner as in the preparation of the photoreceptor 2-A except that the coating liquid R1 for forming a charge transport layer was changed to the coating liquid R5 for forming a charge transport layer.

### Experimental Example 2-6

A photoreceptor 2-F was prepared in the same manner as in the preparation of the photoreceptor 2-A except that the coating liquid R1 for forming a charge transport layer was changed to the coating liquid R6 for forming a charge transport layer.

### Experimental Example 2-7

A photoreceptor 2-G was prepared in the same manner as in the preparation of the photoreceptor 2-A except that the intensity of the LED light having 385 nm was changed to 685 mW/cm² and the irradiation time was changed to 1 minute.

### Experimental Example 2-8

A photoreceptor 2-H was prepared in the same manner as in the preparation of the photoreceptor 2-E except that the intensity of the LED light having 385 nm was changed to 685 mW/cm² and the irradiation time was changed to 1 minute.

### Experimental Example 2-9

A photoreceptor 2-I was prepared in the same manner as in the preparation of the photoreceptor 2-F except that the intensity of the LED light having 385 nm was changed to 685 mW/cm² and the irradiation time was changed to 1 minute.

[Initial Electrical Characteristics]

The initial electrical characteristics of the photoreceptors 2-A to 2-I were measured by the method described above.

In the second embodiment of the present invention, a case where the VL was 75 (−V) or less was evaluated as “acceptable”.

[Strong Exposure Characteristics]

The strong exposure characteristics of the photoreceptors 2-A to 2-I were measured by the method described above.

In the second embodiment of the present invention, a case where absolute values of ΔV0 and ΔVL were as follows was evaluated as “acceptable”.

ΔV0 (immediately after irradiation): 11 or less

ΔV0 (10 minutes after irradiation): 8 or less

ΔV0 (60 minutes after irradiation): 8 or less

ΔVL (immediately after irradiation): 14 or less

ΔVL (10 minutes after irradiation): 10 or less

ΔVL (60 minutes after irradiation): 6 or less

[Transfer Repeatability (Transfer Long)]

The transfer repeatability of the photoreceptors 2-A to 2-I were measured by the method described above.

In the second embodiment of the present invention, a case where an absolute value of ΔVL was 130 or less was evaluated as “acceptable”.

TABLE 5

| | | | | Radical acceptor compound | | | | |
|---|---|---|---|---|---|---|---|---|
| | | | | | | Energy | Content | |
| | | | | | | difference | (part by | |
| | | | | | | (eV) | mass) | |
| | | | | | | between | with | |
| | | | | | | HOMO | respect to | |
| | LED light irradiation condition | | | | Electron | level and | 100 parts | |
| | Wavelength | Intensity | Time | Structural | affinity | LUMO | by mass | |
| | (nm) | (mW/cm²) | (minute) | formula | (eV) | level | of HTM | Additive |
| Experimental | 385 | 1285 | 2 | C | 3.83 | 2.39 | 1.3 | No |
| Example 2-1 | | | | | | | | |
| Experimental | 385 | 1285 | 2 | D | 3.97 | 2.50 | 1.3 | No |
| Example 2-2 | | | | | | | | |
| Experimental | 385 | 1285 | 2 | E | 4.19 | 2.90 | 1.3 | No |
| Example 2-3 | | | | | | | | |
| Experimental | 385 | 1285 | 2 | C | 3.83 | 2.39 | 0.7 | No |
| Example 2-4 | | | | | | | | |
| Experimental | 385 | 1285 | 2 | No | — | — | — | No |
| Example 2-5 | | | | | | | | |
| Experimental | 385 | 1285 | 2 | No | — | — | — | D |
| Example 2-6 | | | | | | | | |
| Experimental | 385 | 685 | 1 | C | 3.83 | 2.39 | 1.3 | No |
| Example 2-7 | | | | | | | | |
| Experimental | 385 | 685 | 1 | No | — | — | — | No |
| Example 2-8 | | | | | | | | |
| Experimental | 385 | 685 | 1 | No | — | — | — | D |
| Example 2-9 | | | | | | | | |

TABLE 6

| | | Strong exposure characteristics | | | | | | |
|---|---|---|---|---|---|---|---|---|
| | Initial | ΔV0 (V) | | | ΔVL (V) | | | |
| | electrical | Immediately | 10 minutes | 60 minutes | Immediately | 10 minutes | 60 minutes | Transfer |
| | characteristics | after | after | after | after | after | after | repeatability |
| | VL (−V) | irradiation | irradiation | irradiation | irradiation | irradiation | irradiation | ΔVL (V) |
| Experimental | 45 | −1 | 0 | 2 | 8 | 4 | 4 | −73 |
| Example 2-1 | | | | | | | | |
| Experimental | 54 | 6 | 1 | 0 | 10 | 7 | 4 | −127 |
| Example 2-2 | | | | | | | | |
| Experimental | 72 | 9 | 7 | 4 | 14 | 10 | 5 | −122 |
| Example 2-3 | | | | | | | | |
| Experimental | 41 | 11 | 8 | 7 | 7 | 3 | 1 | −77 |
| Example 2-4 | | | | | | | | |
| Experimental | 40 | 67 | 44 | 22 | 30 | 29 | 23 | −137 |
| Example 2-5 | | | | | | | | |
| Experimental | 80 | 8 | 7 | 4 | 7 | 1 | −2 | −45 |
| Example 2-6 | | | | | | | | |
| Experimental | 29 | 5 | −2 | −8 | −1 | −5 | −6 | −45 |
| Example 2-7 | | | | | | | | |
| Experimental | 31 | 24 | 16 | 8 | −13 | −27 | −32 | −45 |
| Example 2-8 | | | | | | | | |
| Experimental | 37 | 12 | 9 | 8 | 7 | 10 | 8 | −30 |
| Example 2-9 | | | | | | | | |

It is confirmed from Tables 5 and 6 that when the photosensitive layer contains at least the hole transport material (HTM) and the radical acceptor compound, and the content of the radical acceptor compound in the photosensitive layer is 0.1 part by mass or more and 10 parts by mass or less with respect to 100 parts by mass of the hole transport material (HTM), all of the initial electric characteristics, the strong exposure characteristics, and the transfer repeatability are good.

When comparing Experimental Example 2-1 with Experimental Example 2-5, it is found that when the photosensitive layer contains the electron transport material (ETM) and the hole transport material (HTM), the initial electrical characteristics, the strong exposure characteristics, and the transfer repeatability are all good, and when the photosensitive layer does not contain the electron transport material (ETM), any of the characteristics is poor.

In addition, in Experimental Example 2-6, it is found that, in the case where the photosensitive layer contains a known light shielding agent (the compound of the formula (F)) instead of the electron transport material (ETM) in Experimental Example 2-1, in particular, the initial electrical characteristics are deteriorated. It is presumed that this is because the compound of the formula (F) itself is partly photodecomposed by the curing light (the LED light), and the electrical characteristics are deteriorated due to the influence of the photodecomposition product.

Here, when the photosensitive layer contains not only the hole transport material (HTM) but also the radical acceptor compound (the electron transport material (ETM)), the radical acceptor compound (ETM) is more likely to be radicalized than the HTM. Therefore, it can be considered that even when an HTM radical is generated, the HTM radical immediately extracts a hydrogen atom from the radical acceptor compound (ETM) and is converted into the HTM, thereby exhibiting the effect as in Experimental Example 2-1.

Further, a sheet photoreceptor sample was prepared as follows, and the initial electrical characteristics, the strong exposure characteristics, and the transfer repeatability were evaluated.

### Experimental Example 2-10

A photoreceptor 2-J was prepared in the same manner as in Example 5 described above.

### Experimental Example 2-11

A sheet photoreceptor 2-K was prepared in the same manner as the photoreceptor sheet 2-J except that the coating liquid R7 for forming a charge transport layer was changed to the coating liquid R5 for forming a charge transport layer.

For the sheet photoreceptors 2-J and 2-K, the initial electrical characteristics, the strong exposure characteristics, and the transfer repeatability were measured according to the procedure described above. Each sheet photoreceptor was used for each measurement after conducting with the aluminum vapor-deposited layer of the aluminum cylinder.

Measurement results are shown in Tables 7 and 8.

TABLE 7

| | | | | Radical acceptor compound | | | | |
|---|---|---|---|---|---|---|---|---|
| | | | | | | Energy | Content | |
| | | | | | | difference | (part by | |
| | | | | | | (eV) | mass) | |
| | | | | | | between | with | |
| | | | | | | HOMO | respect to | |
| | LED light irradiation condition | | | | Electron | level and | 100 parts | |
| | Wavelength | Intensity | Time | Structural | affinity | LUMO | by mass | |
| | (nm) | (mW/cm²) | (minute) | formula | (eV) | level | of HTM | Additive |
| Experimental | 385 | 1285 | 2 | H | 3.83 | 2.75 | 1.3 | No |
| Example 2-10 | | | | | | | | |
| Experimental | 385 | 1285 | 2 | No | — | — | — | No |
| Example 2-11 | | | | | | | | |

TABLE 8

| | | Strong exposure characteristics | | | | | | |
|---|---|---|---|---|---|---|---|---|
| | Initial | ΔV0 (V) | | | ΔVL (V) | | | |
| | electrical | Immediately | 10 minutes | 60 minutes | Immediately | 10 minutes | 60 minutes | Transfer |
| | characteristics | after | after | after | after | after | after | repeatability |
| | VL (−V) | irradiation | irradiation | irradiation | irradiation | irradiation | irradiation | ΔVL (V) |
| Experimental | 73 | 9 | 4 | 4 | 4 | 1 | 0 | −62 |
| Example 2-10 | | | | | | | | |
| Experimental | 60 | 3 | 2 | −1 | 1 | −19 | −25 | −103 |
| Example 2-11 | | | | | | | | |

It is confirmed from Tables 7 and 8 that in the case of a sheet-type photoreceptor, as in the case of a drum-type photoreceptor, when the photosensitive layer contains at least the hole transport material (HTM) and the radical acceptor compound, and the content of the radical acceptor compound in the photosensitive layer is 0.1 part by mass or more and 10 parts by mass or less with respect to 100 parts by mass of the hole transport material (HTM), all of the initial electric characteristics, the strong exposure characteristics, and the transfer repeatability are good.

From the results of the above Experimental Examples and the results of the tests conducted by the present inventor, it is found that when the photosensitive layer contains the radical acceptor compound and the hole transport material (HTM), the initial electrical characteristics, the strong exposure characteristics, and the transfer repeatability are excellent. It is presumed that this is because the presence of the radical acceptor compound can prevent the decomposition of the HTM, thereby preventing damage to the photosensitive layer.

Further, when a radical acceptor compound whose energy difference between the HOMO level and the LUMO level is 1.8 eV or more and 3.0 eV or less is used as the radical acceptor compound, particularly, the strong exposure characteristics can be further enhanced due to excellent light-shielding ability.

1. An electrophotographic photoreceptor comprising:
a conductive support; and
a photosensitive layer and a protective layer comprising a cured product obtained by curing a curable compound, which are sequentially disposed on the conductive support, wherein
an area ratio A/B is 0.0045 or less, where A is an absorbance area at a wavelength of 1647 cm⁻¹ to 1627 cm⁻¹ and B is an absorbance area of a peak at a wavelength of 1800 cm⁻¹ to 1647 cm⁻¹ in an infrared absorption spectrum measurement of the protective layer, and
the photosensitive layer comprises a hole transport material (HTM) and a radical acceptor compound.

2. The electrophotographic photoreceptor according to claim 1, wherein
the photosensitive layer comprises 0.1 part by mass to 10 parts by mass of the radical acceptor compound with respect to 100 parts by mass of the hole transport material (HTM).

3. An electrophotographic photoreceptor comprising:
a conductive support; and
a photosensitive layer and a protective layer comprising a cured product obtained by curing a curable compound, which are sequentially disposed on the conductive support, wherein
the photosensitive layer comprises a hole transport material (HTM) and a radical acceptor compound, and
a content of the radical acceptor compound in the photosensitive layer is 0.1 part by mass or more and 10 parts by mass or less with respect to 100 parts by mass of the hole transport material (HTM).

4. The electrophotographic photoreceptor according to claim 1, wherein
the hole transport material (HTM) and the radical acceptor compound are present in a same layer.

5. The electrophotographic photoreceptor according to claim 1, wherein
the curable compound comprises a photocurable compound.

6. The electrophotographic photoreceptor according to claim 1, wherein
an energy difference between a HOMO level and a LUMO level of the radical acceptor compound is 1.8 eV or more and 3.0 eV or less.

7. The electrophotographic photoreceptor according to claim 1, wherein
an energy difference between a HOMO level and a LUMO level of the hole transport material (HTM) is larger than the energy difference between the HOMO level and the LUMO level of the radical acceptor compound.

8. The electrophotographic photoreceptor according to claim 7, wherein
the energy difference between the HOMO level and the LUMO level of the hole transport material (HTM) is 3.6 eV or less.

9. The electrophotographic photoreceptor according to claim 1, wherein
the photosensitive layer is a multi-layered photosensitive layer comprising a charge generation layer and a charge transport layer in this order.

10. The electrophotographic photoreceptor according to claim 1, wherein
the protective layer comprises 0 part by mass or more and 20 parts by mass or less of inorganic particles with respect to 100 parts by mass of the protective layer.

11. The electrophotographic photoreceptor according to claim 1, wherein
the hole transport material (HTM) comprises a compound having a triphenylamine structure.

12. The electrophotographic photoreceptor according to claim 1, wherein
the radical acceptor compound comprises a compound having a diphenoquinone structure or a dinaphthylquinone structure.

13. The electrophotographic photoreceptor according to claim 1, wherein
the protective layer comprises the curable compound and a polymerization initiator.

14. The electrophotographic photoreceptor according to claim 1, wherein
the protective layer comprises a layer cured by irradiation with ultraviolet light and/or visible light.

15. A cartridge comprising:
the electrophotographic photoreceptor according to claim 1.

16. An image forming device comprising:
the electrophotographic photoreceptor according to claim 1.
